(19) United States
(12) Patent Application Publication
(10) Pub. No.: US 2018/0043652 A1
(43) Pub. Date: Feb. 15, 2018

(54) CONTROLLING FRICTION CHARACTERISTICS OF RESILIENT MEMBERS USING NEAR-SURFACE MICROSTRUCTURES

(71) Applicants: Lehigh University, Bethlehem, PA (US); Compagnie Generale Des Etablissements Michelin, Clermont-Ferrand (FR)

(72) Inventors: Anand Jagota, Bethlehem, PA (US); Ying Bai, Amherst, MA (US); Zhenping He, Bethlehem, PA (US); Chung-Yuen Hui, Ithaca, NY (US); Benjamin Levrard, Blanzat (FR)

(73) Assignees: Lehigh University, Bethlehem, PA (US); Compagnie Generale Des Etablissements Michelin, Clermont-Ferrand (FR)

(21) Appl. No.: 15/551,630

(22) PCT Filed: Feb. 17, 2016
(86) PCT No.: PCT/US2016/018332

§ 371 Date: Aug. 17, 2017

Related U.S. Application Data
(60) Provisional application No. 62/117,236, filed on Feb. 17, 2015.

(51) Int. Cl. B32B 3/08; C09J 7/02; B32B 27/08; B32B 3/30; B32B 7/06

(52) U.S. Cl. CPC B32B 3/08; B32B 3/30; B32B 7/06; B32B 27/08; C09J 7/0253; B32B 2274/00; B32B 2475/00; C09J 2201/626

(57) ABSTRACT

Resilient members having near-surface architectures including microstructures for controlling friction are provided. A film-terminated array of fibrils having a sharp film/fibril juncture exhibits an unexpectedly large enhancement of adhesion, static friction and sliding friction. The enhancement is provided against rough indenters. A film-terminated array of elongated ridges and valleys unexpectedly exhibits low adhesion, and an unexpectedly large enhancement of sliding friction. The film-terminated ridge/valley design provides an anisotropic structure with direction-dependent frictional properties. The increase in sliding friction force varies as a function of interfibrillar spacing, and corresponds to a mode in which buckling of the terminal film occurs. The near surface architectures may be designed with varying scales and varying parameters to provide performance characteristics tailored to various applications. By way of example, the film-terminated ridge/valley array may be incorporated in motor vehicles tires to provide low rolling resistance and high sliding friction allow for high-performance braking during vehicle operation.

### FIELD OF THE INVENTION

The present invention relates generally to controlling friction characteristics of resilient members, and more particularly to resilient members having near-surface architectures including microstructures for controlling friction characteristics.

### BACKGROUND

Friction arises whenever two members in contact move relative to each other, and its deliberate control is central for the functioning of a variety of phenomena. Friction characteristics, and resulting impact on friction performance, of resilient members is commercially relevant in a wide variety of industries and fields of endeavor. Depending upon the application, higher or lower friction may be desirable. By way of example, friction characteristics of elastomeric members is of great practical importance in the contexts of automobile tires, windshield wipers, and seals. Typical attempts to control friction have been either at the molecular scale or at the continuum scale. In the former case, friction arises due to molecular stick-slip; in the latter, it couples to bulk viscoelastic losses and can be controlled by macroscopic design of structures, such as tire treads.

Relatively recent work on bio-inspired structures has shown how contact mechanical properties, including both friction and adhesion, can be significantly modified by appropriate design of near-surface architecture of resilient members. For example, it has been recognized that certain near-surface architectures may be successful in enhancing adhesion in elastomers. By way of example, one conventional resilient member 10 has a structure including a generally solid or continuous backing layer 12 and a fibrillar array 14 that includes a plurality of correspondingly spaced fibrils 16 extending generally transversely to a direction of elongation of the backing layer, as shown in FIG. 1. Each fibril has a distal end that includes a landing pad surface 18 having a surface area greater than a cross-section of the corresponding fibril. The landing pads lie generally in a plane to collectively provide a contact surface that is discontinuous. Referring now to the alternative example shown in FIG. 2, another conventional resilient member 20 has a structure including a generally solid or continuous backing layer 22 and a near-surface architecture including a plurality of internal channels 24 extending generally parallel to, or otherwise in a direction of elongation of, the backing layer. This structure provides a contact surface 26 that is continuous.

Another example is the certain film-terminated fibrillar structure shown in FIG. 3. This exemplary resilient member 30 includes a near-surface film-terminated fibrillar structure. This exemplary elastomeric member 30 may be formed by molding an elastomeric material, such as polydimethylsiloxane (PDMS), in or on a mold (such as a silicon wafer) that defines a plurality of spaced holes to form a generally solid or continuous backing layer 32 and a fibrillar array 34 that includes a plurality of correspondingly spaced fibrils 36 extending generally transversely (e.g., at an angle of 90 degrees or less) to a direction of elongation of the backing layer and terminating in free distal ends, as will be best appreciated from in FIG. 3. The exemplary elastomeric member 30 further includes a contact film layer 38, which may be formed, for example, by spin coating or dip coating a curable material (such as PDMS) in a liquid state onto a flat substrate. The contact film layer 38 is then joined to the free distal ends of the fibrils to form a unitary resilient member 30, as shown in FIG. 3. It is understood that such joining has typically been performed by placing the uncured or predominantly-uncured/partially-uncured contact film layer 38 (which may still be supported on the substrate) into contact with the fibrils 36, and then subsequently curing the contact film to cause the curable material to progress to its final solid state. The result of this and other conventional processes can provide a flow of uncured material between the distal ends of the fibrils and the contact film layer, and a resulting a thickened region 39 that provides a smooth juncture, perhaps having a constant of varying radius, between each fibril 36 and the contact film layer 38, as shown in FIG. 3.

The resilient members having these exemplary near-surface architectures have been found to provide enhanced adhesion and static friction characteristics. However, such resilient members have been found to provide sliding friction characteristics that are generally reduced or substantially unchanged relative to a flat control body, rather than increased. It is believed that the reduction in sliding friction characteristics has been due to deformation of the near-surface structures that result in a breaking of contact that ultimately reduces the area of contact, and as a result reduces sliding friction forces. Further, to the extent that these exemplary resilient members have been found to increase static friction, the increased static friction has been observed relative to relatively smooth surfaces, e.g., by relying upon testing using smooth indenters having a surface having a root mean square roughness less than about 1 nanometer, as measured over an area measuring about 10 micrometers by 10 micrometers, or less than about 15 nanometers, as measured over an area measuring about 100 micrometers by 100 micrometers. The inventors have recognized that such smooth surfaces are not characteristic of many common surfaces, which are relatively rough, such as typical roadway surfaces. Thus, structures for providing adequate friction forces relative to a smooth indenter may not be useful in designing automotive tires, shoe treads, or the like that encounter common rough surfaces, such as typical roadway surfaces.

What is needed are resilient members having near-surface architectures for (1) controlling, e.g., increasing, sliding friction characteristics of resilient members, and (2) controlling, e.g., increase, static friction characteristics of resilient members against rough surfaces, such as typical roadway surfaces.

### SUMMARY

The present invention provides resilient members having near-surface architectures including microstructures for controlling sliding friction and/or controlling static friction over rough surfaces. In one embodiment, the near surface architecture includes a film-terminated array of discrete fibrils having a sharp film/fibril juncture. A film-terminated fibrillar structure exhibits substantial static friction regardless of whether the film/fibril juncture is sharp or rounded. However, it has been determined that the sharp or rounded nature unexpectedly dramatically impact sliding friction performance. More specifically, when the juncture is rounded, sliding friction remains roughly equal to that of a control unstructured surface. However, when the juncture is sharp, sliding friction is unexpectedly greatly enhanced for a large separation between fibrils.

In another embodiment, the near-surface architecture includes a film-terminated array of elongated ridges and valleys. The film-terminated ridge-valley design provides an anisotropic structure with direction-dependent frictional properties. In this structure, static friction does not peak dramatically or sharply with a change in ridge spacing. However, it has been found unexpectedly, that the sliding friction can be either greatly attenuated (by providing a small distance between ridges) or greatly enhanced (by providing a large distance between ridges) as compared to a flat unstructured control.

In accordance with the present invention, we have determined that by varying the combinations of backing layer, fibrils/ridge, and contact film layer materials/characteristics (e.g., elastic modulus), and/or by varying the near-surface structure architecture geometry (e.g., fibril/ridge height, fibril cross-section, ridge width, right length fibril/ridge spacing/width, film thickness, etc.) friction characteristics of a resilient member can be controlled, i.e., be selectively increased, decreased, or otherwise defined. More particularly, in accordance with the present invention, it has been determined, unexpectedly, that these parameters can be selectively combined to cause a contact surface to enter different modes of deformation, in response to contact with a surface, that is different from the typical mode of deformation, and that provides a disproportional increase in static and/or sliding friction force.

More particularly, it has been determined, unexpectedly, that a resilient member having a near surface architecture including a film-terminated fibrillar array having a sharp film/fibril juncture exhibits an unexpectedly large increase in static friction force when in contact with a rough indenter as a function of interfibrillar spacing. It is noted however, that a sharp film/fibril juncture is not required for high static friction performance; rather, similar performance may be obtained with a rounded juncture. It is believed that this increase in static friction force is due to a crack-trapping mechanism resulting from microstructures that collectively provide adjacent regions of relatively high compliance (contact film unsupported by supportive fibril structure) and relatively low compliance (contact film supported by supportive fibril structure).

Further, it has been determined, unexpectedly, that a resilient member having a near surface architecture including a film-terminated ridge/valley array exhibits an unexpectedly large increase in sliding friction force when in contact with indenters as a function of interfibrillar spacing. It is believed that at sufficient spacing levels, the mechanism providing sliding friction changes, and that rather than simply bend/deform as when the near surface supportive structures are relatively closely spaced, the near-surface structure undergoes, at microscopic levels, repeated folding of the contact film layer and/or the ridges, and that as a result, the resilient member stores a significant amount of internal energy that is then subsequently released in a manner that increases sliding friction. In addition, the repeated folding causes internal sliding that also increases sliding friction by dissipating externally provided work.

It is believed that in these alternative modes of deformation, the mechanism providing static or sliding friction changes, and that rather than simply bend/deform in a conventional fashion, the near-surface structure instead undergoes, at a microscopic levels, complex deformations that result in enhanced crack trapping among fibrils or a series of internal folds of the contact film layer and/or ridges.

### BRIEF DESCRIPTION OF THE DRAWINGS

The present invention will now be described by way of example with reference to the following drawings in which:

FIG. 1 is an isometric view of an exemplary prior art resilient member including a near-surface fibrillar architecture in which each fibril terminates in an enlarged landing pad;

FIG. 2 is an isometric view of an exemplary prior art resilient member including a near-surface internal channel architecture;

FIG. 3 is a scanning electron micrograph (SEM) image of an exemplary prior art resilient member having a near-surface architecture including a film-terminated fibrillar array having a smooth film/fibril juncture;

FIG. 4 shows an exemplary resilient member having a near-surface architecture including a film-terminated fibrillar array having a sharp film/fibril juncture in accordance with an exemplary embodiment of the present invention;

FIG. 5 is an optical micrograph showing deformation of an exemplary prior art resilient member, similar to that of FIG. 3, in response to contact with a smooth indenter prior to sliding;

FIG. 6 is an optical micrograph showing deformation of an exemplary novel film-terminated fibrillar array having a sharp film/fibril junctures, similar to that of FIG. 4, in response to contact with a smooth indenter during sliding;

FIG. 7 shows a graph of sliding friction force relative to smooth indenter displacement for a variety of resilient members including film-terminated fibrillar structures, similar to that of FIG. 4, having various fibril spacings;

FIG. 8a is a graph showing normalized friction force as a function of fibril spacing for a prior art structure similar to that of FIG. 3;

FIG. 8b is a graph showing friction force as a function of indenter displacement for a prior art structure similar to that of FIG. 3;

FIGS. 9a and 9b are graphs showing friction force as a function of displacement as a smooth indenter, and rough indenter, respectively, traverses resilient members having a near-surface architecture including a film-terminated fibrillar structure having a sharp fibril/film juncture;

FIGS. 10a-10c are optical micrographs showing deformation of resilient members including film-terminated fibrillar structures;

FIGS. 11, 13, 15, 17, 19 and 21 are graphs showing friction force as a function of displacement in relation to various exemplary rough indenters;

FIGS. 12a-12d, 14a-14d, 16a-16d, 18a-18d, 20a-20d and 22a-22d show optical micrographs showing deformation of exemplary resilient members in response to contact with various exemplary rough indenters;

FIG. 23 is an image of a ridged backing layer of an exemplary film-terminated ridge array in accordance with the present invention, shown prior to addition of the terminal film;

FIG. 24 is an SEM image of an exemplary resilient member including a near-surface architecture comprising a film-terminated ridge array in accordance with an alternative embodiment of the present invention;

FIG. 25 is an image showing deformation of an exemplary resilient member including a film-terminated ridge array in response to contact with a smooth indenter as is moves in a direction of elongation of the ridges;

FIG. 26 is an image showing deformation of an exemplary resilient member including a film-terminated ridge array in response to contact with a smooth indenter as is moves in a direction transverse to the direction of elongation of the ridges;

FIG. 27 is a graph showing friction force as a function of indenter displacement, for different inter-ridge spacing, transverse to a direction of elongation of ridges in a film-terminated ridge structure;

FIGS. 28a-28d are optical micrographs showing deformation of an exemplary film-terminated ridge structure in response to indenter displacement transverse to a direction of elongation of the ridges;

FIGS. 28e, 29, 30, 31 and 32 are graphs showing friction force as a function of indenter displacement transverse to a direction of elongation of ridges in a film-terminated ridge structure;

FIGS. 33-35 are graphs showing friction force as a function of indenter displacement along a direction of elongation of ridges in a film-terminated ridge structure;

FIGS. 36-1 to 36-4 show optical micrographs showing deformation of an exemplary film-terminated ridge structure in response to indenter displacement transverse to a direction of elongation of the ridges;

FIGS. 37-1 to 37-4 show optical micrographs showing deformation of an exemplary film-terminated ridge structure in response to indenter displacement in a direction of elongation of the ridges;

FIG. 38 shows a graph of force as a function of indenter displacement normal to a plane for four different specimens, namely, (a) a flat unstructured control, (b) a film-terminated fibrillar structure in accordance with the present invention, and (c) and (d) two film-terminated ridge structures in accordance with the present invention; and

FIG. 39 shows a graph of maximum adhesive force (normalized by its value for a flat unstructured control) as a function of periodic spacing in (a) two film-terminated ridge structures in accordance with the present invention, and (b) a film-terminated fibrillar (or pillar) structure.

### DETAILED DESCRIPTION

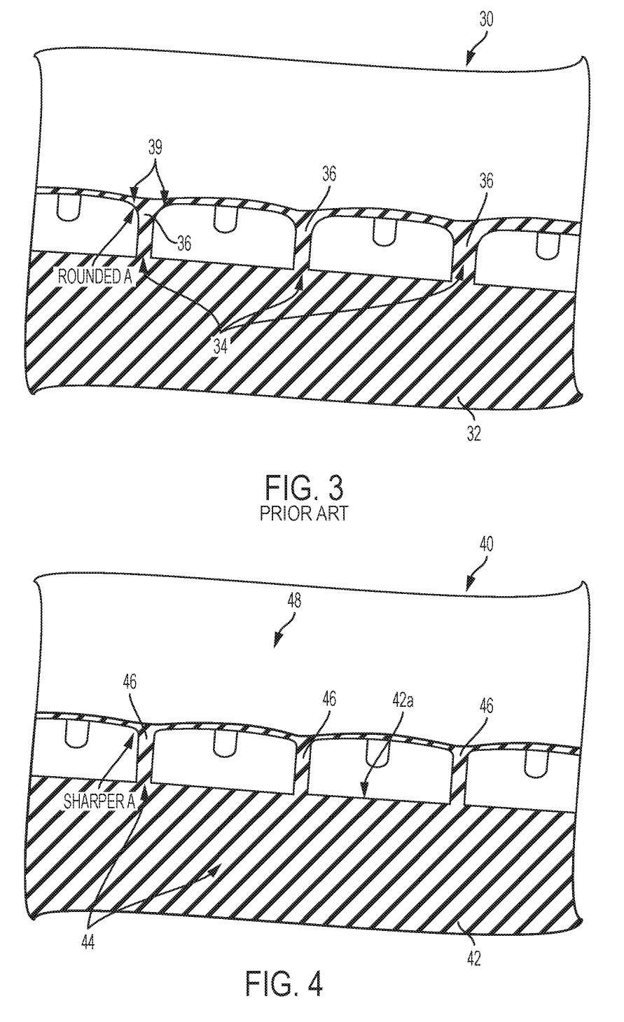

The present invention provides resilient members having near-surface architectures including microstructures for controlling (e.g., enhancing) sliding friction and/or controlling (e.g., enhancing) static friction over smooth and/or rough surfaces. In accordance with one aspect of the present invention, a resilient member is provided that has a near-surface architecture including a film-terminated array of discrete fibrils having a sharp film/fibril juncture. Referring now to FIG. 4, an exemplary resilient member 40 is shown. Somewhat similar to conventional resilient members having a near surface architecture including a film-terminated array of discrete fibrils, this exemplary resilient member 40 includes a generally solid or continuous backing layer 42 and a fibrillar array 44 that includes a plurality of spaced fibrils 46 extending generally transversely to a direction of elongation of the backing layer, from an upper surface 42a of the backing layer. This backing layer and fibrillar array may be formed in a conventional process, e.g., by molding an elastomeric material (such as PDMS) in or on a mold (such as a silicon wafer) that defines a plurality of spaced holes or channels to form corresponding fibrils. As is typical of the prior art, the fibrils may be disposed in a variety of conventional patterns, such as square or hexagonal patterns, with uniform spacing.

Somewhat similarly to conventional resilient members, the novel resilient member 40 further includes a contact film layer 48, which may be formed, for example, by spin coating or dip coating a curable material (such as PDMS) in a liquid state onto a flat substrate. The contact film layer 48 is joined to the ends of the fibrils opposite the ends adjacent the backing layer 42, and the resilient member 40 is a unitary member. Unlike the conventional resilient member 30 shown in FIG. 3, however, the novel resilient member 40 shown in FIG. 4 does not have a thickened region that provides a smooth juncture, perhaps having a constant or a varying radius, between each fibril 46 and the contact film layer 48, as shown in FIG. 3. Rather, the novel resilient member 40 defines a sharp film/fibril juncture, as best shown in FIG. 4, and as best appreciated by a comparison of FIG. 4 with FIG. 3. Accordingly, unlike the resilient member 30 shown in FIG. 3, the surface of the fibrils 46 join an adjacent surface of the contact film layer to form substantially a right angle. For example, any irregularity in the formation of a right angle at the junction of the contact film layer 48 and the fibril 46 may be characterized as having a radius, or profile, of less than about 2 micrometers, or alternatively, less than about 20% of the width of the fibril. Accordingly, the contact film 48 is substantially flat and/or has a substantially constant thickness. Further, in certain embodiments, the fibril has a substantially constant cross-section that does not vary adjacent a junction with the contact film layer 48, as shown in FIG. 4.

This exemplary resilient member 40 having a sharp fibril/film juncture consistent with the present invention may be formed by partially curing the uncured film layer to cause it to progress from a liquid state to a solid state, or a substantially solid state, before placing the contact film layer 48 into contact with the fibrils 46, and then subsequently completing the curing of the contact film layer, or re-curing the contact film layer, to cause joining of the fibrils to the contact film layer. Alternative processes may be used for fabricating the resilient member, or for joining the contact film and fibrils, provided that the process avoids the contact of a sufficiently “wet” uncured film layer with the fibrils that will result in a flow of uncured material between the distal end of the fibrils and the contact film layer, and/or a resulting thickened region at the film/fibril juncture. By way of example, the entire resilient member 40 could be formed as a unitary member, and resulting joining of separately fabricated backing layer/fibrils and film layers could be avoided, e.g., using subsurface inclusions that can be later removed by dissolution, or by manufacturing a unitary structure using a 3D printing process, or causing bonding of a manufactured contact film layer with a manufactured backing/fibril layer, e.g., using an ultrasonic welding/heating. Any suitable technique may be used to manufacture the resilient member 40.

In accordance with the present invention, we have determined that by varying the dimensions, geometry and other parameters of micrometer-scale structures in a near surface architecture of a resilient member, friction characteristics of the resilient member can be controlled. More specifically, by varying the combinations of backing layer, fibrils, and contact film layer materials/characteristics (e.g., elastic modulus), and/or by varying the near-surface structure architecture geometry (e.g., fibril/ridge height, fibril cross-section, ridge width, right length fibril/ridge spacing/width, film thickness, film material properties, etc.) friction characteristics of a resilient member can be controlled, i.e., be selectively increased, decreased, or otherwise defined. In accordance with the present invention, it has been determined that, unexpectedly, if the spacing between adjacent structures in a near-surface architecture is increased sufficiently, but not excessively, a significant and disproportional increase in friction force is provided.

More particularly, it has been determined, unexpectedly, that a resilient member having a near surface architecture including a film-terminated fibrillar array having a sharp film/fibril juncture exhibits an unexpectedly large increase in static friction force when in contact with a rough indenter as a function of interfibrillar spacing. It is believed that this increase in static friction force is due to a crack-trapping mechanism resulting from microstructures that collectively provide adjacent regions of relatively high compliance (contact film unsupported by supportive fibril structure) and relatively low compliance (contact film supported by supportive fibril structure).

Further, it has been determined, unexpectedly, that a resilient member having a near surface architecture including a film-terminated ridge/valley array having a sharp film/ridge juncture exhibits an unexpectedly large increase in sliding friction force when in contact with indenters as a function of interfibrillar spacing. It is believed that at sufficient spacing levels, the mechanism providing sliding friction changes, and that rather than simply bend/deform as when the near surface supportive structures are relatively closely spaced, the near-surface structure undergoes, at microscopic levels, repeated folding of the contact film layer and/or the ridges, and that as a result, the resilient member stores a significant amount of internal energy that is then subsequently released in a manner that increases sliding friction. In addition, the repeated folding causes internal sliding that also increases sliding friction by dissipating externally provided work.

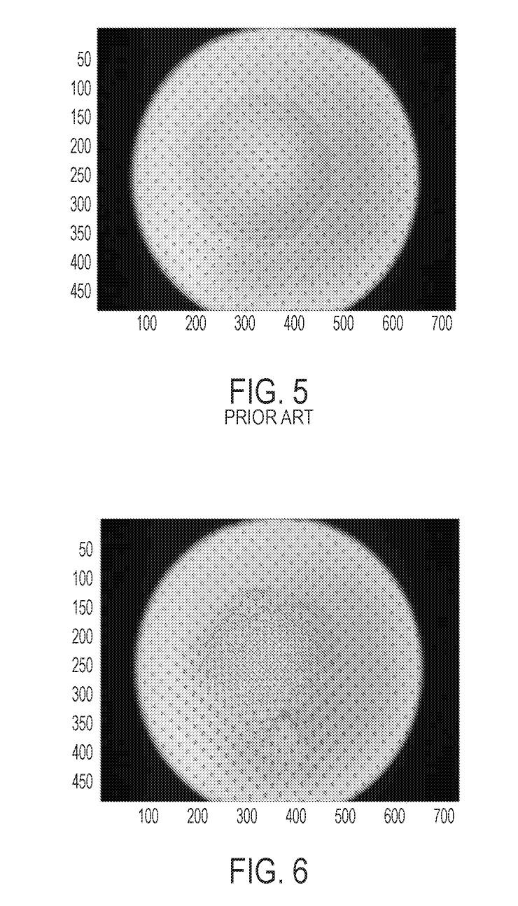

The difference in deformation of the near-surface architectures can be seen in FIGS. 5 and 6, which are optical micrographs showing deformation in response to contact with a smooth indenter of resilient members having film-terminated fibrillar arrays. FIG. 5 shows deformation of the exemplary prior art resilient member of FIG. 3, as viewed through the base layer, while in contact with a smooth indenter under a normal load. Deformation of the contact film layer in a shape corresponding to a contact area resulting from the shape of a round, smooth indenter is plainly visible in FIG. 5. FIG. 6 is an optical micrograph showing deformation of the novel resilient member 40 of FIG. 4 in response to contact with a similar smooth indenter under normal and shear load. As is plainly visible from FIG. 6, there is a deformation pattern generally corresponding to the shape of the round, smooth indenter, but the deformation pattern reflects crack trapping under shear forces that results in increased static friction force due to the configuration of the microstructures of the resilient member's near surface architecture. The optical micrograph of FIG. 5 was obtained in a friction test without a shear load. The optical micrograph of FIG. 6 was obtained in a friction test with a shear load, in which a smooth glass indenter was placed into contact with the resilient member under a normal load of 0.1 grams, and subjected to a force in a direction along/across the surface of the resilient member (in an upwards direction in FIG. 6) at a rate of 5 micrometers/second. In the example of FIG. 6, the resilient member is constructed of PDMS, the backing layer has a thickness of 700 micrometers, the fibrils are arranged in a square pattern, the fibrils have a nominal length/height (D) of 30 micrometers above a top surface of the backing layer, and the nominal spacing (S) between adjacent fibrils is about 100 micrometers.

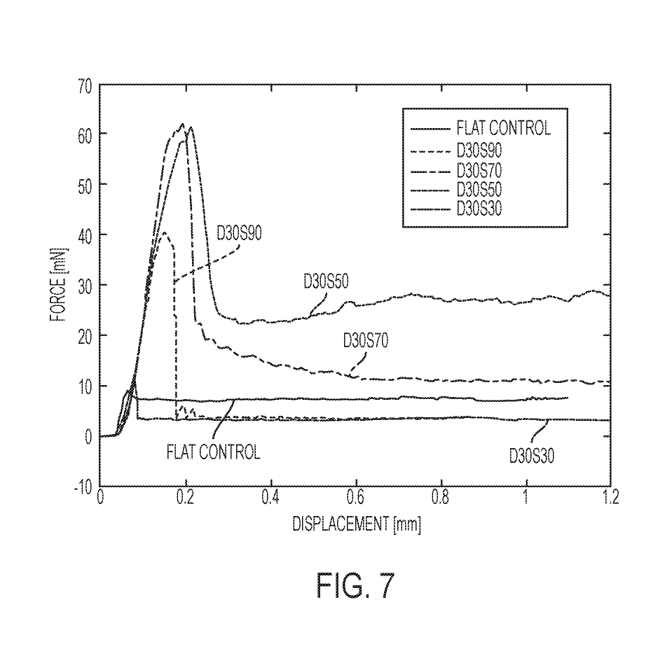

FIG. 7 shows a graph of friction force as a function of displacement of a smooth indenter (e.g., a hemispherical glass member having a radius in the range of 1-4 mm), in a friction test of PDMS resilient member samples. The graph shows friction force curves for a plurality of resilient member samples (similar in structure to that of FIG. 4) in relation to a flat control structure that does not have a near-surface architecture including microstructures, but rather is simply solid, flat, and/or continuous. Each of the resilient member samples has a common fibril height (D) of 30 micrometers (nominally), but varying spacing between the fibrils ranging from 30-90 micrometers (nominally). As shown in FIG. 7, adding microstructures having small and increasing spacing provides increased static friction but lower sliding friction, relative to the flat sample, as shown for the D30S30 and D30S50 samples. Static friction force is effectively the maximum friction force resisting motion between two contact surface prior to the beginning of a state of slipping between the resilient member and the surface with which it is in contact. The static friction force is generally represented by a peak the friction force curve. Sliding friction force is effectively the friction force resisting continued slipping while there is relative motion between the resilient member and a surface with which it is in contact.

Unexpectedly, further increasing the spacing between adjacent fibrils results in increased static friction force and increased sliding friction force, and in fact results in static friction force of about 4 to 6 times more than the static friction force exhibited by a flat sample, and a sliding friction force of about 1.5-3 times more than the sliding friction force exhibited by the flat sample. Accordingly, friction force is unexpectedly greatly affected by small changes in spacing between the fibrils, and further can result in increased friction force in limited conditions.

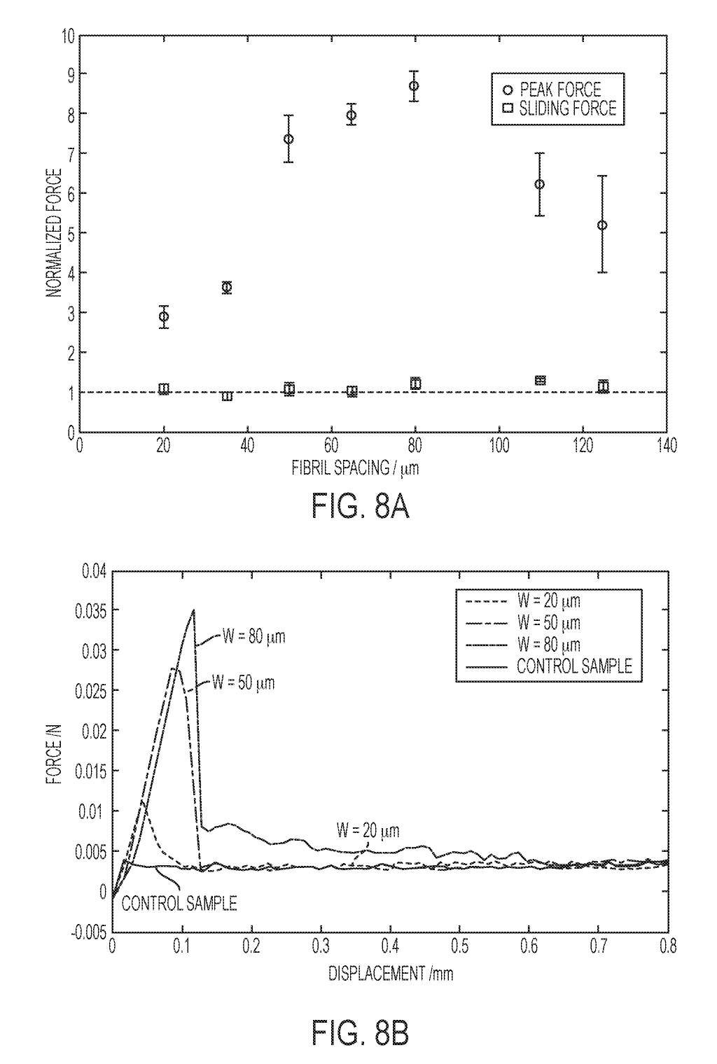

FIGS. 8a and 8b shows force-displacement data during friction measurement of a conventional film-terminated fibrillar resilient member 30 of in FIG. 3. In contrast, FIG. 7 shows force-displacement data during friction measurement of a novel film-terminated fibrillar resilient member having a sharp film/fibril juncture, similar to that of FIG. 4. As will be noted by a comparison of the figures, the static friction force is greatly enhanced by an increase in interfibril spacing. However, sliding friction force increases within increasing interfibril spacing only with respect to the novel film-terminated fibrillar resilient member having a sharp film/fibril juncture, as shown in FIG. 7. Thus, the near-surface architecture of a film-terminated fibrillar resilient member having a sharp fibril/film juncture can be designed to control sliding friction by varying the fibril spacing, for a given set of material elastic modulus, film thickness, fibril height, and fibril cross-section parameters. These parameters can be varied as well to control the resulting sliding friction characteristics of a resilient member. More specifically, these parameters can be varied so that, in combination, they provide a resilient member providing a desired level of sliding friction force for a defined load condition.

Further, we have determined, unexpectedly, that the near-surface architecture of a film-terminated fibrillar resilient member having a sharp fibril/film juncture can be designed to control static and sliding friction by varying the fibril spacing, for a given set of material elastic modulus, film thickness, fibril height, and fibril cross-section parameters. These parameters can be varied as well to control the resulting static friction characteristics of a resilient member in relation to rough surface, such as a roadway. More specifically, these parameters can be varied so that, in combination, they provide a resilient member providing a desired level of static friction force for a defined load condition.

By way of example, a rough indenter may be a spherical body having surface topography with a root mean square roughness of 100 nanometers as measured over a 10 micron×10 micron area, or may be a naturally rough stone.

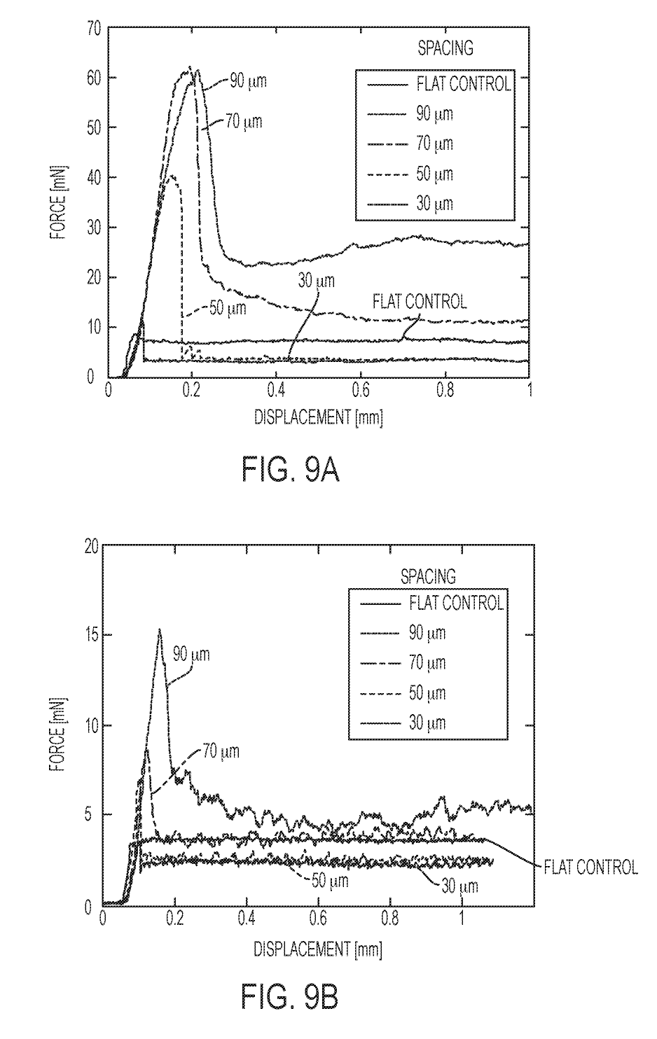

FIGS. 9a and 9b show differences in static friction forces in relation to smooth and rough indenters. Static friction of the inventive film-terminated fibrillar structure having a sharp fibril/film juncture is up to 10 times that of a flat control, when measured against a smooth indenter, as shown in FIG. 9a. More specifically, FIG. 9a shows data for film-terminated fibrillar resilient members having a sharp fibril/film juncture, similar to that shown in FIG. 4, having a fibril height (D) of 30 micrometers, fibril spacing (S) in a square pattern and fibril spacings ranging from 30 micrometers to 90 micrometers. As shown in FIG. 9a, the static friction unexpectedly increases dramatically with increasing spacing between fibrils, as discussed above. In contrast to previous reports, we have determined that, unexpectedly, sliding friction force can also be enhanced or otherwise controlled by near-surface architecture including film-terminated fibrillar resilient members having a sharp fibril/film juncture, as shown in FIG. 9a. FIG. 9b shows corresponding measurements using a rough indenter. FIG. 9b illustrates that static friction force is strongly attenuated against a rough surface for all the resilient members, which in this case vary in interfibrillar spacing from 30-90 micrometers. FIG. 9b further illustrates that, unexpectedly, the enhancement of the static friction force of the structured surface in comparison to that of the flat control remains considerable in that it is increased by a factor of up to about 5 for the D30S90 resilient member sample, but that resilient members having more closely spaced fibrils provided lower static friction force, and in some cases, static friction forces lower than that of the flat control.

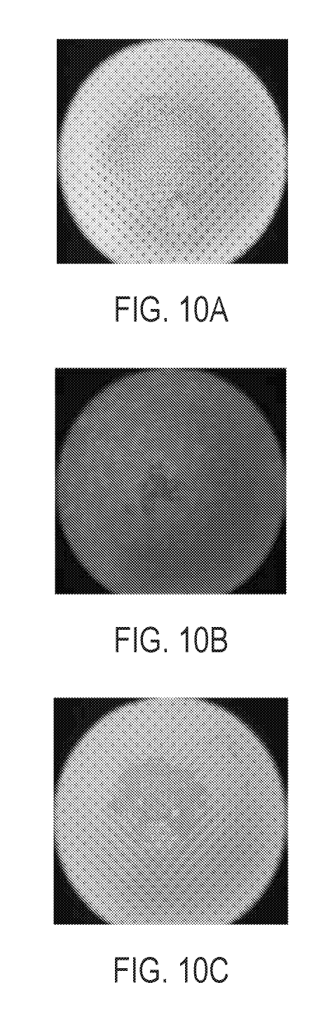

FIG. 10a shows an optical micrograph of the contact region of film-terminated fibrillar resilient members having a sharp fibril/film juncture during sliding of the contact film layer against a smooth indenter. In comparison, FIG. 10b shows an optical micrograph of the contact region during sliding of a flat control against a rough indenter. The drastic reduction in actual area of contact due to roughness of the indenter is apparent and explains, as expected, the corresponding reduction in friction. By way of further comparison, FIG. 10c shows an optical micrograph of a contact region during sliding of the same structured surface against a rough indenter. As will be noted from a comparison of the micrographs of FIGS. 10b and 10c, the actual area of contact is considerably enhanced for the film-terminated fibrillar resilient members having a sharp fibril/film juncture, as seen in FIG. 10c.

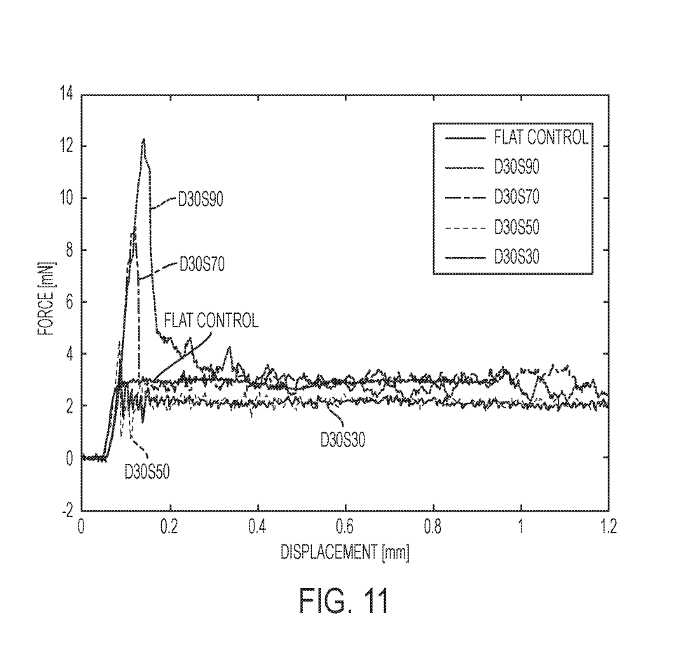

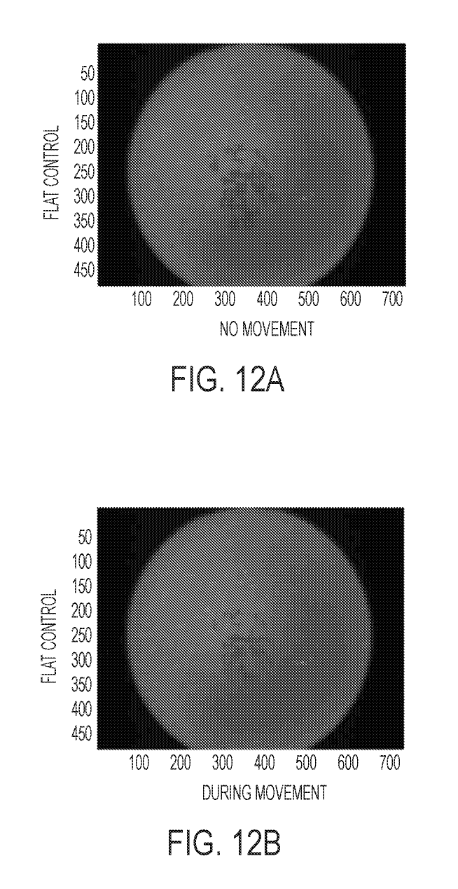

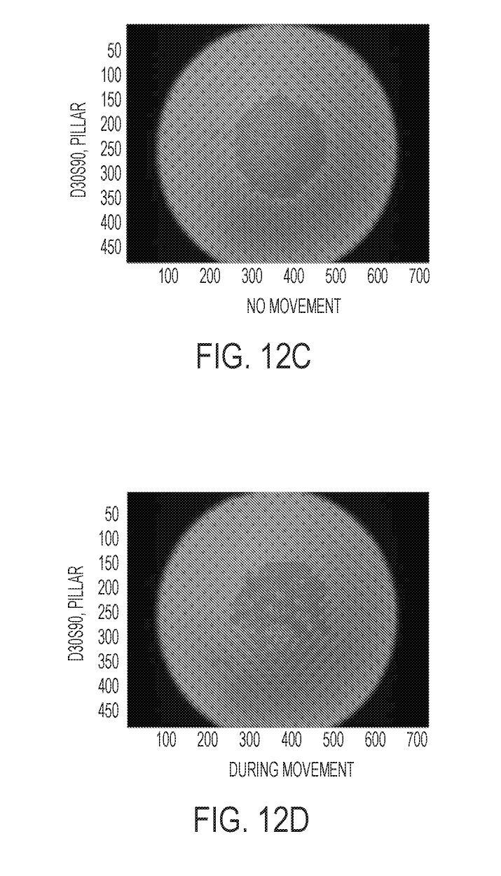

FIG. 11 shows data for film-terminated fibrillar resilient members having a sharp fibril/film juncture, similar to that shown in FIG. 4, having a fibril height (D) of 30 micrometers, fibril spacing (S) in a square pattern and fibril spacings ranging from 30 micrometers to 90 micrometers. This test involved use of a rough indenter in the form of a roughened glass sphere. As shown in FIG. 11, varying the interfibril spacing has an unexpected impact on friction forces in a friction test in which a rough indenter (P1) is moved across film-terminated fibrillar resilient members having a sharp fibril/film juncture. FIG. 11 shows that static friction force unexpectedly increases by a factor of about 4, relative to a flat control sample, for a film-terminated fibrillar resilient members having a sharp fibril/film juncture and a spacing of 90 micrometers, and further shows a very slight increase in sliding force relative to a flat control. Relative to the flat control, adding and/or increasing spacings of 30 or 50 micrometers lessens static and sliding friction. Unexpectedly, further increasing the spacings to 70 or 90 micrometers increases static and sliding friction, not only relative to flat control, but also relative to the smaller spacings. As can be seen from FIGS. 12a-12d, during movement of the rough indenter across the D30S90 film-terminated fibrillar resilient member having a sharp fibril/film juncture, folds in the contact film layer and/or fibrillar members are formed, as shown in FIG. 12d.

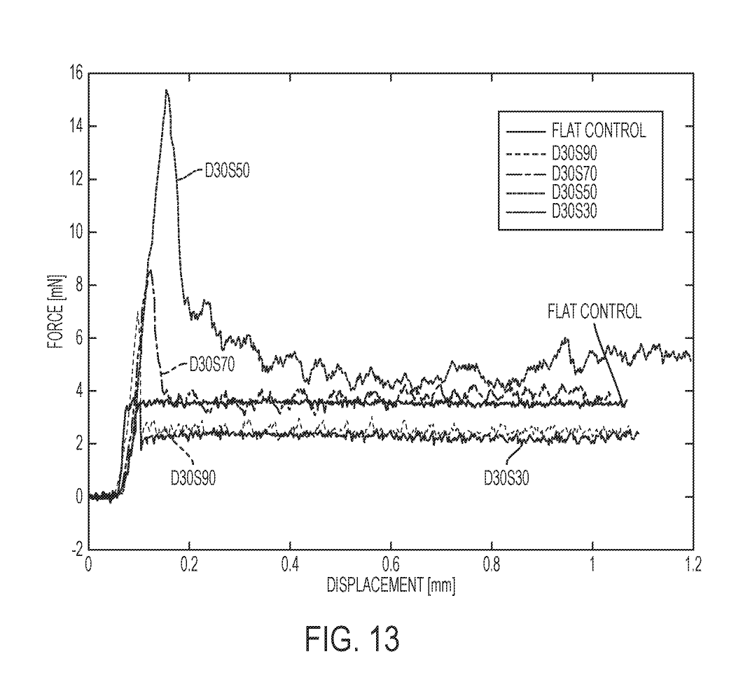

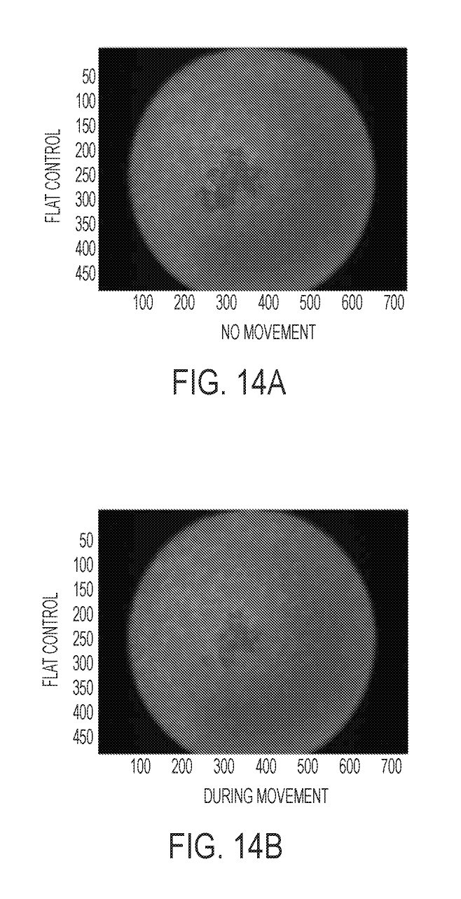

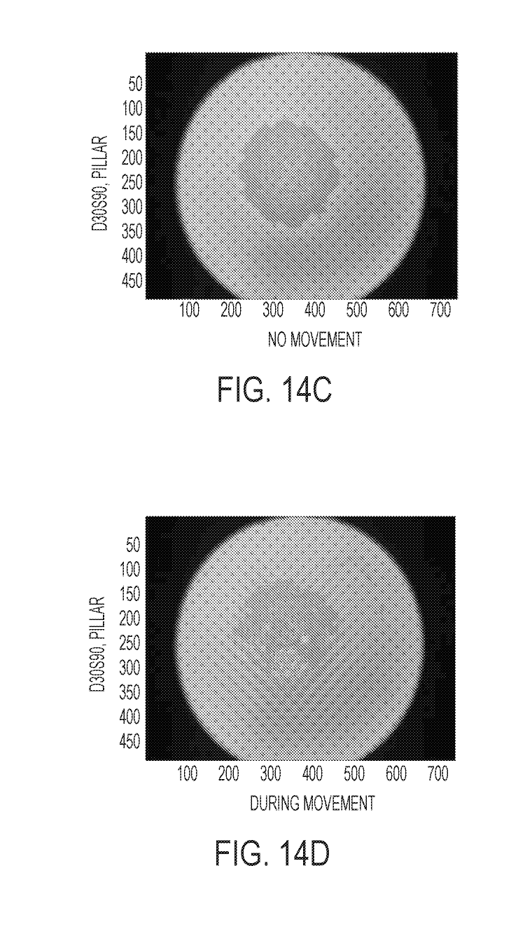

FIG. 13 shows a similar pattern of results with respect to a different rough indenter (F2). This rough indenter is in the form of a roughened glass sphere. Again, during movement of the rough indenter across the D30S90 film-terminated fibrillar resilient members having a sharp fibril/film juncture, folds in the contact film layer and/or fibrillar members are formed, as shown in FIG. 14d.

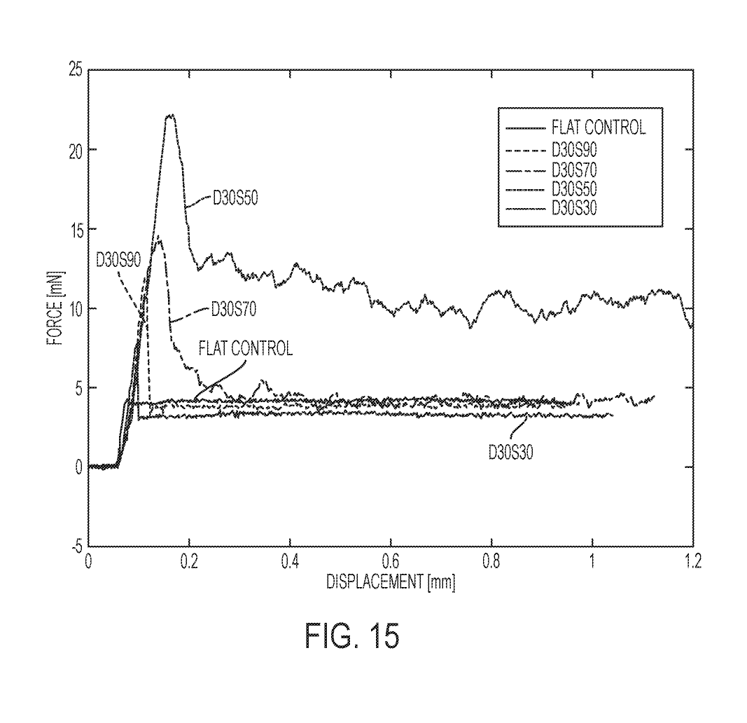

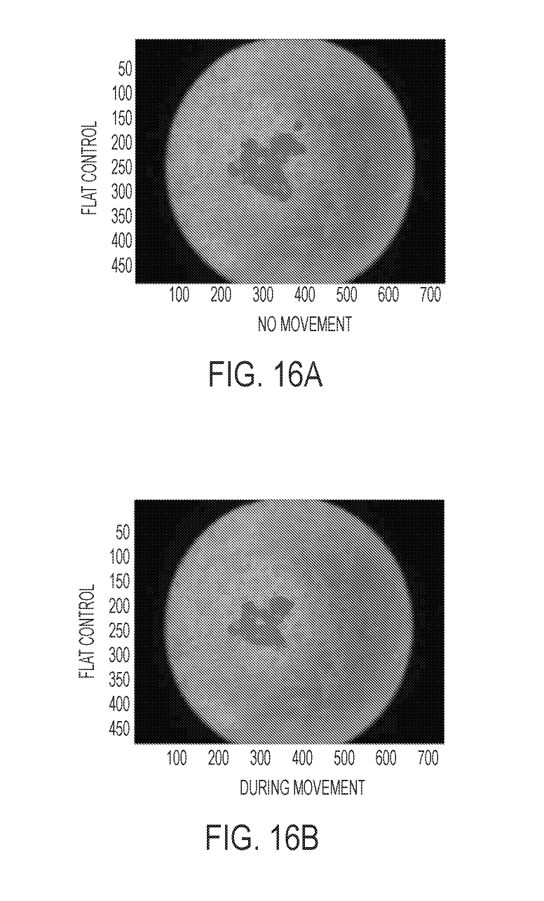

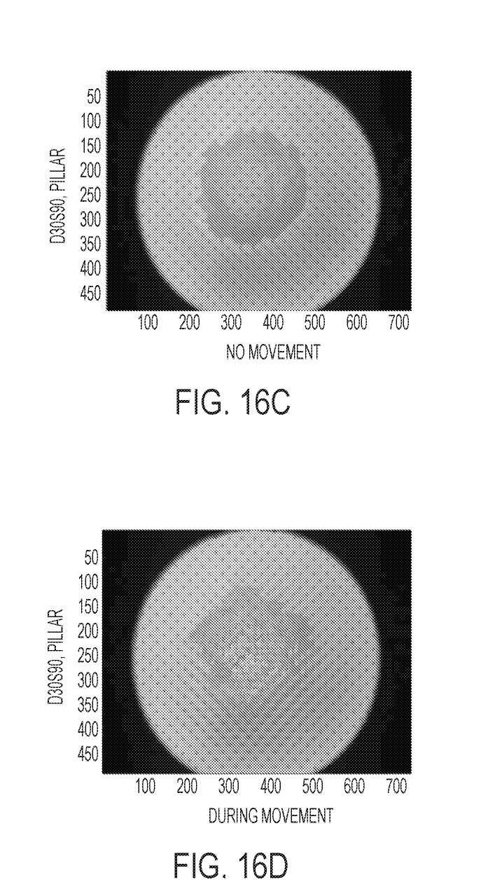

FIG. 15 shows a similar pattern of results with respect to a different rough indenter (C1). This rough indenter is in the form of another roughened glass sphere. Again, during movement of the rough indenter across the D30S90 film-terminated fibrillar resilient members having a sharp fibril/film juncture, folds in the contact film layer and/or fibrillar members are formed, as shown in FIG. 16d.

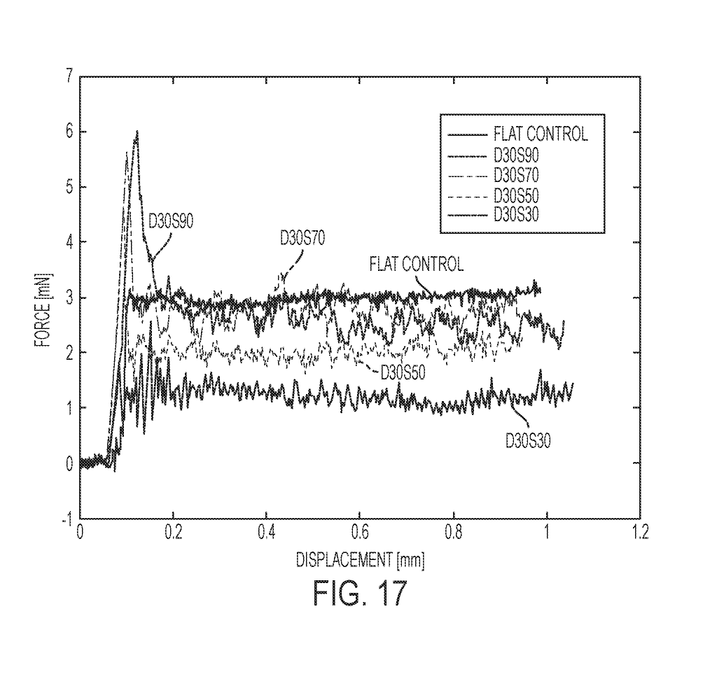

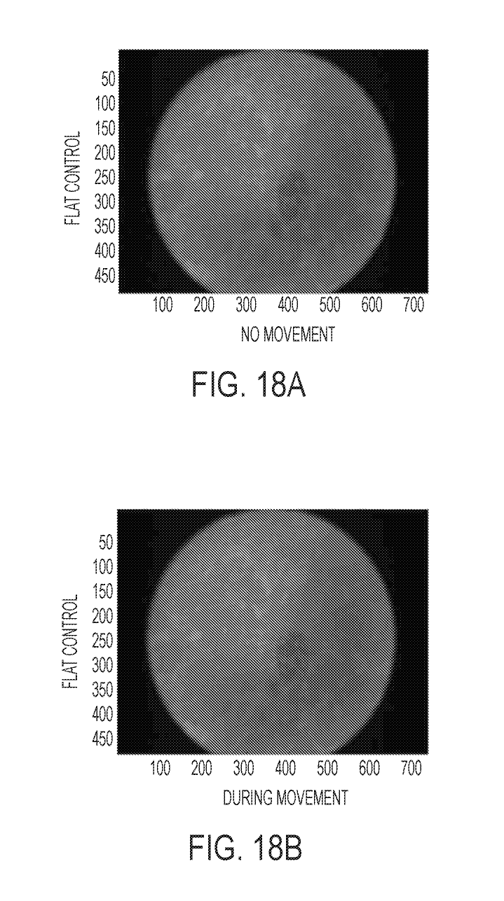

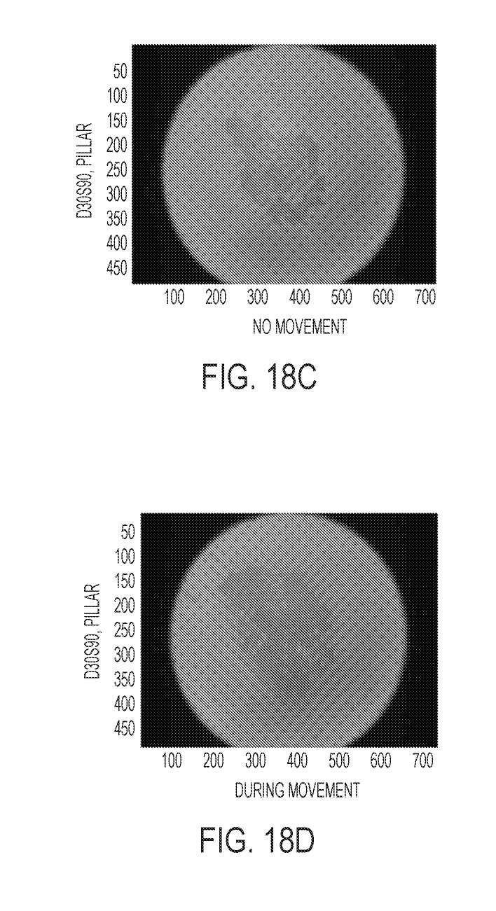

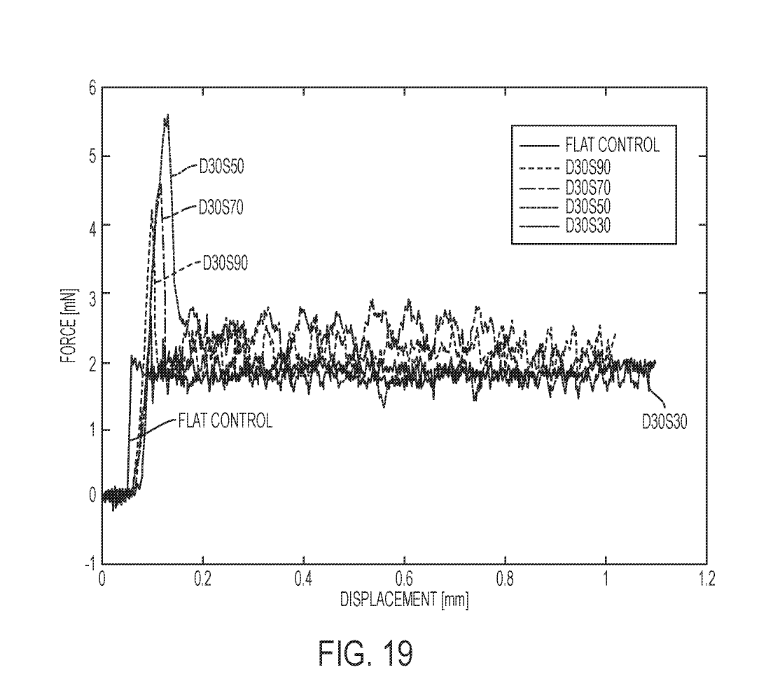

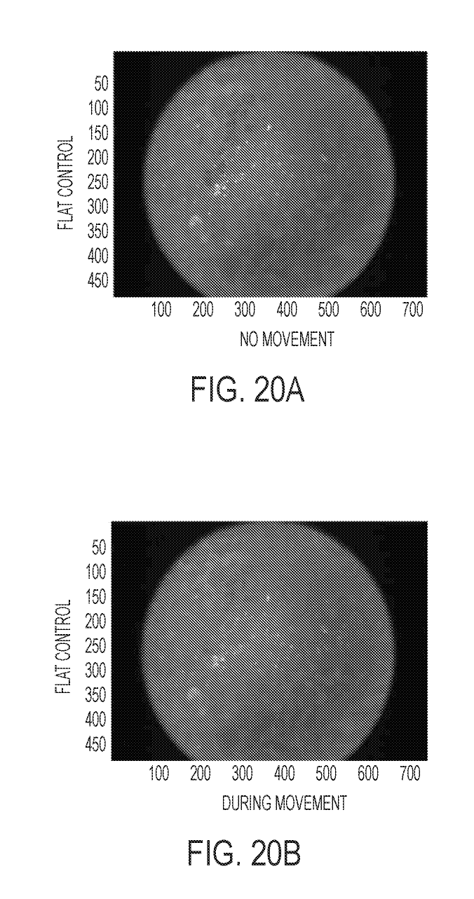

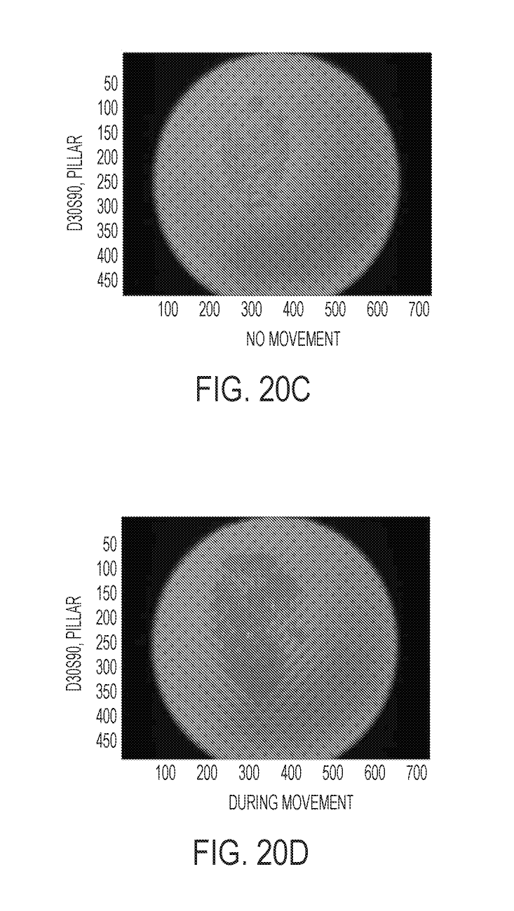

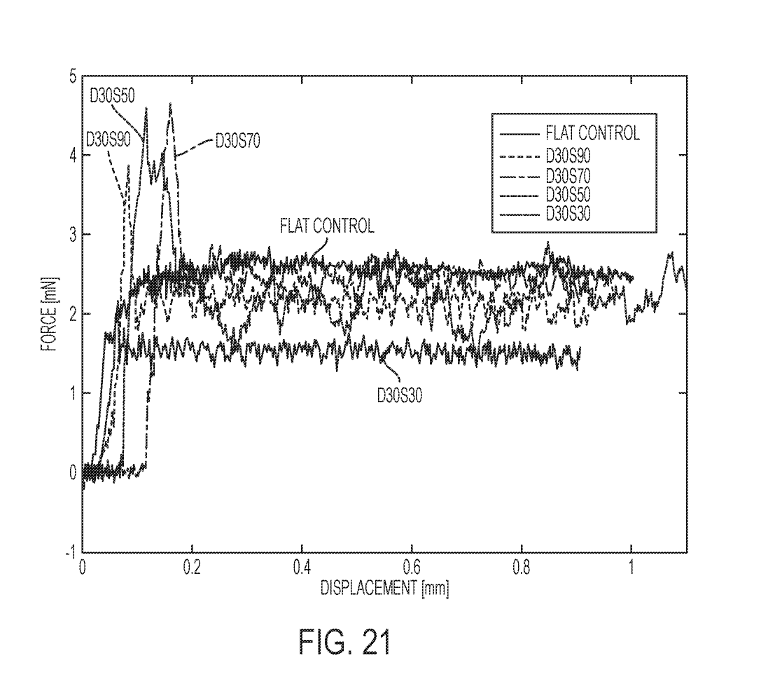

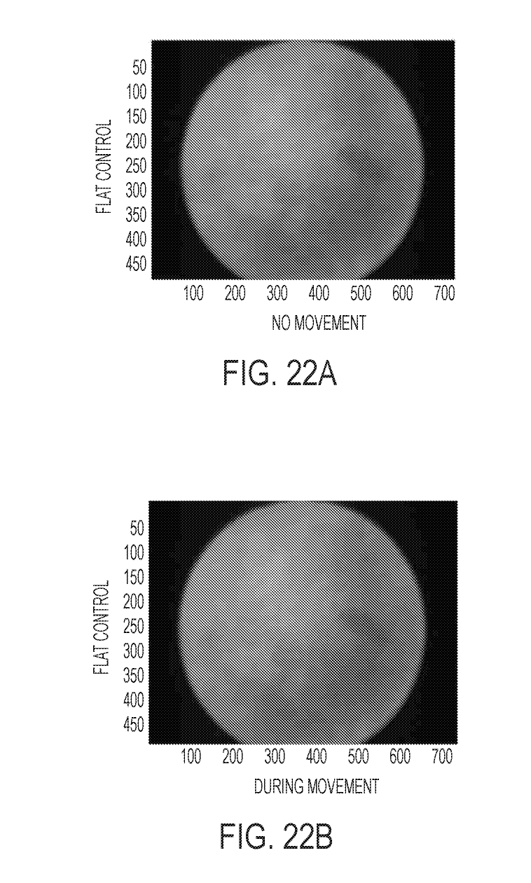

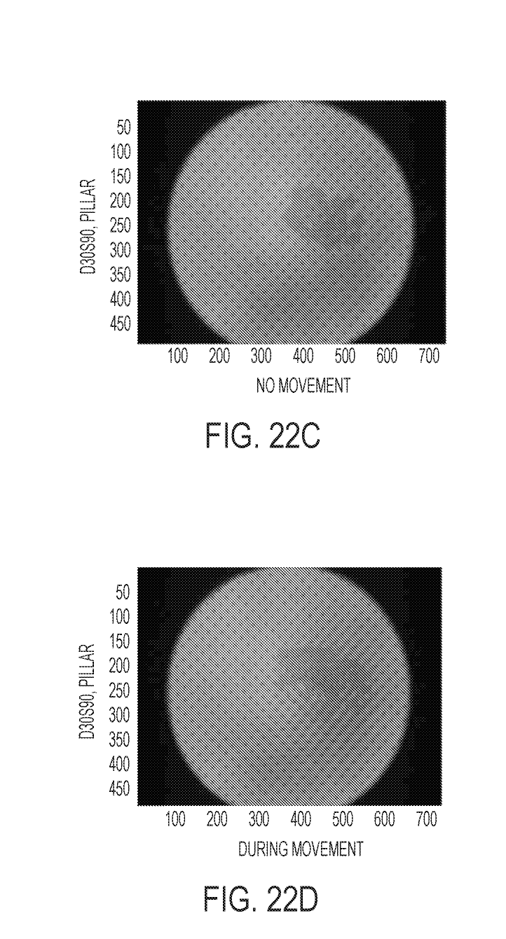

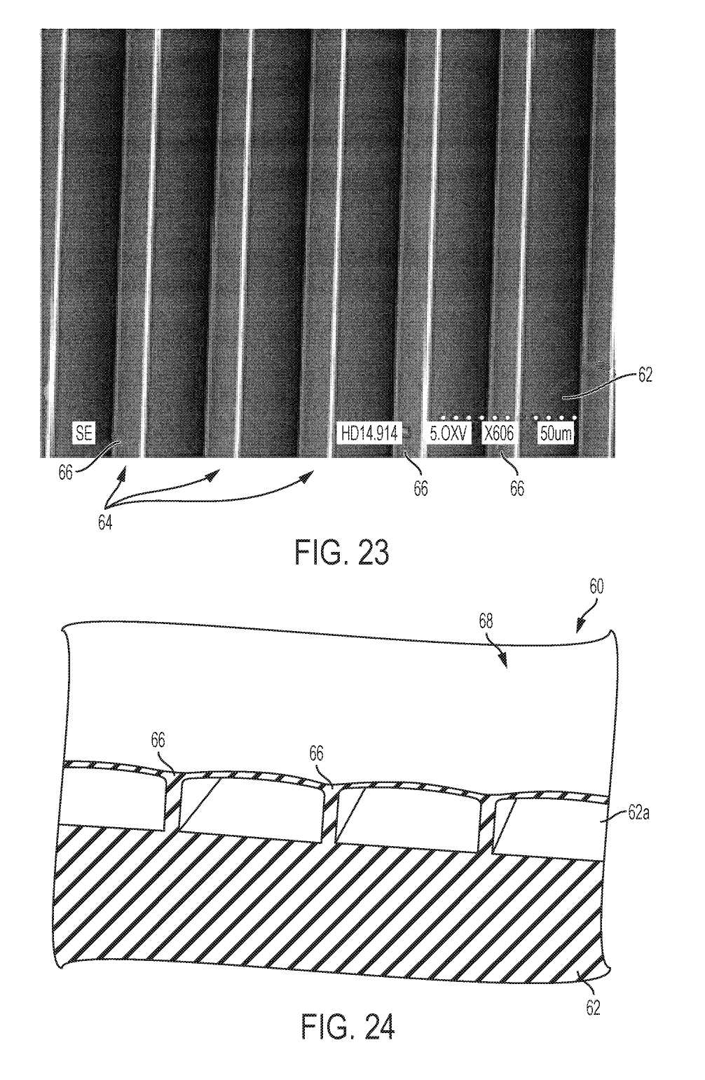

Similar patterns of results relative to other rough indenters are shown in FIGS. 17, 19 and 21, and similar folds are shown in corresponding images of FIGS. 18a-18d, 20a-20d and 22a-d. Rough indenters S2, S3 and S4 are natural stone indenters having rough surfaces. A variety of samples of rough indenters having a root mean square roughness of approximately 2300 nanometers to approximately 6000 nanometers over a region of about 200 microns by 200 microns were tested in an adhesion test, in which the indenter is contacted with and them removed from a film-terminated fibrillar structure having a sharp fibril/film juncture, as described above, and were found to exhibit enhanced adhesion, as represented by normalized pull-off force normalized relative to a flat control sample, for a range of samples in which pillars were arranged in a square pattern with pillar spacings ranging from 20 micrometers to 90 micrometers. More particularly, adhesion characteristics were improved by an increase in pull off force of about 2 to 7 times that of the control sample.

Parameters for such a film-terminated fibrillar structure may be selected in combination to provide the enhanced adhesion properties in accordance with the following relationship:

W˜Wₒ(1+αw⁴/t³h), in which:

W is the Work of Adhesion (J/m²);

Wₒ is the adhesion of the control (J/m²);

w is the spacing between fibrils (m);

t is the film thickness (m);

h is the fibril height (m); and

α is a dimensionless constant that is a function of the fibril pattern, and ˜7.3 10⁻⁴, for a square patterned fibril arrangement.

It is noted that there are some limitations to unlimited scaling of properties according to this relationship. For example, it has been determined that cavitation, fibril fracture and terminal/contact film collapse all play roles that limit the extent to which the work of adhesion can be increased in accordance with the relationship provided above. Accordingly, scaling the film-terminated fibrillar structure to achieve enhanced adhesion performance should not be increased to the extent that cavitation begins to occurring during loading within a desired load range. Cavitation tends to decrease adhesion performance.

Cavitation is governed by the following relationship:

W=(σ_{c}²Ah/\sqrt{3}E)/w², in which:

W is the Work of Adhesion (J/m²);

σ_{c} is a characteristic cavitation stress, established experimentally (N/m²);

A is the cross-sectional area of each fibril (m²);

E is the Young's modulus of the material/elastomer (N/m²);

w is the spacing between fibrils (m); and

h is the height of each fibril (m).

This equation provides a constraint the previous one. For example, the first equation indicates a strong growth of W if the work of adhesion and static friction are increased by increasing w. However, this second equation indicates that W will decrease with increasing w. Accordingly, the second equation establishes a lower performance envelope predicted by these two equations. In other words, as w is increased, the work of adhesion or static friction will first increase, and will then decrease. These two equations can be used in a similar way with respect to other variables, e.g., h.

Further, scaling the film-terminated fibrillar structure to achieve enhanced adhesion performance should be limited to avoid an increase to the extent that the fibrils break during loading within a desired load range. Fibril breakage/fracture tends to decrease adhesion performance.

Further, scaling the film-terminated fibrillar structure to achieve enhance adhesion performance should be limited to avoid an increase to the extent that the terminal/contact film collapses during loading within a desired load range. Film collapse tends to decrease adhesion performance. Film collapse is governed by the following relationship:

9w⁴Wₒ/(Et³h²)>315, in which:

w is the spacing between fibrils (m);

Wₒ is the adhesion between control unstructured surfaces (J/m²);

E is Young's modulus of the material (N/m²);

t is film thickness (m); and

h is the fibril height (m).

Stated differently, the parameters above should be selected to maintain the relationship above to avoid film collapse.

With respect to such a film-terminated fibrillar structure having a sharp fibril/film juncture, it has been determined that in addition to such structures further show strongly enhanced static friction.

Accordingly, as described above in relation to FIGS. 4-22, resilient members having a near-surface architecture including a film-terminated fibrillar array having a sharp fibril/film junction can be designed to provide enhanced static friction force, and to provide enhanced sliding friction force, by varying the combination of backing layer, fibrils (or ridges, as discussed below), and/or contact film layer materials/characteristics (e.g., elastic modulus), and/or by varying the near-surface structure architecture geometry (e.g., fibril height, fibril cross-section, fibril width, fibril spacing, film thickness, etc.) to cause the resilient member to enter a deformation mode involving crack trapping in response to a defined load condition.

The resilient members having a near-surface architectures including a film-terminated fibrillar array having a sharp fibril/film juncture described above has square-patterned, hexagonal-patterned, or otherwise isotropic placement of fibrils about the backing layer, and thus provides isotropic frictional characteristics. In particular, it has been found that spacing and/or other geometry can be varied to provide for a deformation mode involving crack trapping between adjacent microstructures of the resilient member, even with a rough indenter, and further that the static friction forces can be dramatically increased, through slightly increased spacing, though such resilient members have been found to provide relatively little change in sliding friction compared to a flat control. More particularly, this is especially true in embodiments in which the juncture between the fibril and film is rounded. However, if the juncture is sharp, then in certain instances there is an enhancement of sliding friction as well (for larger spacings).

In many applications, such as for automobile tires, one cares specifically about friction along certain directions. Accordingly, an anisotropic structure providing anisotropic frictional characteristics is desirable in some applications.

In another embodiment of the present invention, the near-surface architecture of the resilient member includes a film-terminated array of elongated ridges separated by intervening valleys. Referring now to FIGS. 23 and 24, a resilient member 60 having a near-surface architecture including an anisotropic film-terminated ridge structure is shown. The film-terminated ridge structure can be designed to provide enhanced static friction force, and to provide enhanced sliding friction force, by varying the combination of backing layer, ridge, and contact film layer materials/characteristics (e.g., elastic modulus), and/or by varying the near-surface structure architecture geometry (e.g., ridge width, ridge cross-section, ridge height, ridge length, ridge spacing, film thickness, etc.) to cause the resilient member to enter a deformation mode involving folding of the contact film layer and/or ridges in response to a defined load condition.

Referring now to FIG. 24, this exemplary resilient member 60 has a near-surface architecture including a film-terminated array of discrete, elongated ridges. More particularly, this exemplary resilient member 60 includes a generally solid or continuous backing layer 62 and a ridge array 64 including a plurality of spaced ridges 66, as best shown in FIG. 23. The spacing forms a valley between adjacent ridges. Each ridge 66 extends along an upper surface 62a of the backing layer 62 generally transversely to a direction of elongation of the backing layer. This backing layer and ridge array may be formed in a conventional process, e.g., by molding an elastomeric material (such as PDMS) in or on a mold (such as a silicon wafer) that defines a plurality of spaced grooves to form corresponding ridges. The ridges may be disposed relative to one another in various configurations. In the exemplary embodiment shown, the ridges are disposed in a parallel array with uniform spacing between each pair of adjacent ridges.

Somewhat similarly to conventional resilient members, the novel resilient member 60 further includes a contact film layer 68, as best shown in FIG. 24 (the film being removed in FIG. 23 for illustrative clarity). The contact film layer 68 may be formed, for example, by spin coating or dip coating a curable material (such as PDMS) in a liquid state onto a flat substrate. The contact film layer 68 is joined to the ends of the ridges opposite the ends adjacent the backing layer 62, and the resilient member 60 is a unitary member.

The resilient member may or may not have a thickened region that provides a smooth juncture, perhaps having a constant or a varying radius, between each ridge 66 and the contact film layer 68. The exemplary resilient member 60 defines a sharp film/ridge juncture, as best shown in FIG. 24. The exemplary contact film layer 68 is substantially flat and/or has a substantially constant thickness. Further, in certain embodiments, each ridge has a substantially constant cross-section that does not vary along the length of the ridge. In other embodiments, the thickness of the contact film layer and/or the cross-section of the ridge may vary.

This exemplary resilient member 60 consistent with the present invention may be formed by partially curing the uncured film layer to cause it to progress from a liquid state to a solid state, or a substantially solid state, before placing the contact film layer 68 into contact with the ridges 66, and then subsequently completing the curing of the contact film layer, or re-curing the contact film layer, to cause joining of the ridges to the contact film layer. The exemplary resilient member 60 is formed of PDMS, has a backing layer that is 700 micrometers thick, each ridge has a width (D) 10 micrometers wide, a ridge height of 40 micrometers, and a spacing (S) between adjacent ridges of 115 micrometers. The contact film layer has a thickness in the range of 5-10 micrometers.

Alternative processes may be used for fabricating the resilient member, or for joining the contact film and ridges. By way of example, the entire resilient member 60 could be formed as a unitary member, and resulting joining of separately fabricated backing layer/ridges and film layer could be avoided, e.g., using subsurface inclusions that can be later removed by dissolution, or by manufacturing a unitary structure using a 3D printing process, or causing bonding of a manufactured contact film layer with a manufactured backing/ridge layer, e.g., using an ultrasonic welding/heating. Any suitable technique may be used to manufacture the resilient member 60.

As discussed above in accordance with the present invention, it has been determined that, unexpectedly, if the spacing between adjacent microstructures in a near-surface architecture is increased sufficiently, in combination with certain other properties, a significant and disproportional increase in friction is provided. It is believed that at sufficient spacing levels, the mechanism providing sliding friction changes, and that rather than simply bend/deform as when the near-surface structures are relatively closely spaced, the near-surface structure undergoes, at a microscopic level, repeated folding of the contact film layer and/or the ridges, and that as a result, the resilient member stores a significant amount of internal energy that is then subsequently released in a manner that increases sliding friction.

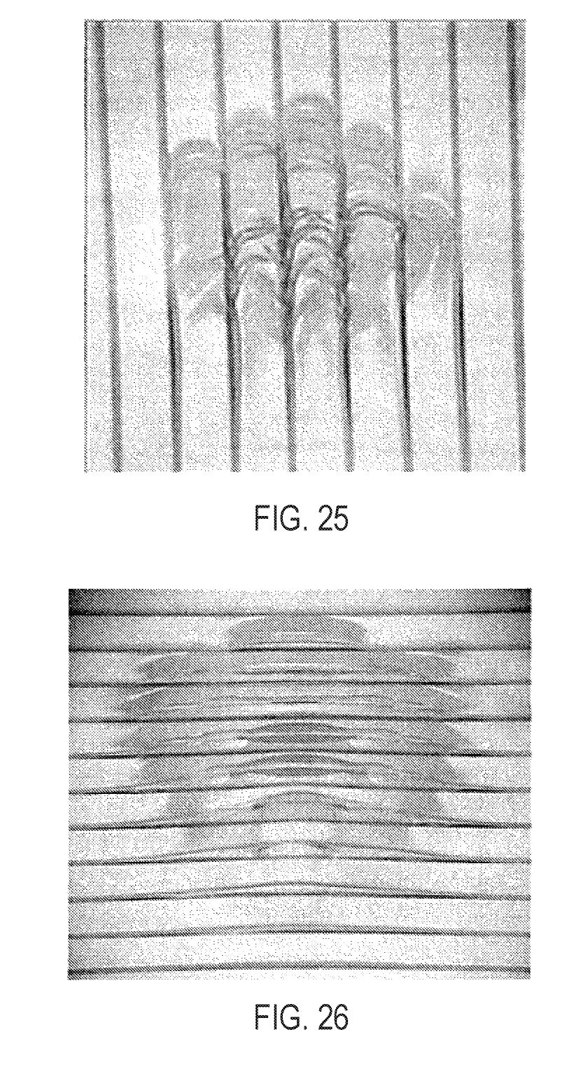

Further, resilient members having a near-surface architecture including a film-terminated ridge structure provides this fold-based mode of deformation, and thus provides substantial increases in friction levels in certain ranges of near-surface geometry. Further, the anisotropic film-terminated ridge structure provides this mode of folding deformation anisotropically, namely, differently along the direction of elongation of the ridges (as shown in FIG. 25), as compared to in a direction transverse to the direction of elongation of the ridges (as shown in FIG. 26). FIGS. 25 and 26 show deformation of the exemplary prior art resilient member of FIG. 24, as viewed through the base layer, while an indenter is pressed against its contact film layer. As is plainly visible from FIGS. 25 and 26, there are folds in the contact film layer and/or ridges, which appear as a plurality of short straight or curved lines in FIGS. 25 and 26. The optical micrographs of FIGS. 25 and 26 were obtained in friction tests in which an indenter was pressed against the resilient member with a load of 0.1 grams, and moved across the surface of the resilient member (in an upwards direction in FIGS. 25 and 26) at a rate of 5 micrometers/second.

Notably, the folding mechanisms are different in the two different orthogonal directions. With respect to sliding friction in a direction transverse to the direction of elongation of the ridges, a substantial increase in sliding friction force is provided when the microstructures are configured so that the contact film and the ridge structures fold in response to a defined load condition. In this deformation mode, the ridges are believed to bend/deform into a space defined between adjacent ridges, as shown in FIG. 26, which can provide a sharp increase in sliding friction.

With respect to sliding friction in a direction of elongation of the ridges, a lesser increase in sliding friction force is provided when the microstructures are configured so that the contact film and the ridge structures fold in response to a defined load condition. In this deformation mode, the ridges do not bend/deform into a space defined between adjacent ridges (due to the orientation of the spaces and the direction of the applied force), but rather bend/deform buckle upon themselves, as shown in FIG. 25, which provides a lesser increase in sliding friction.

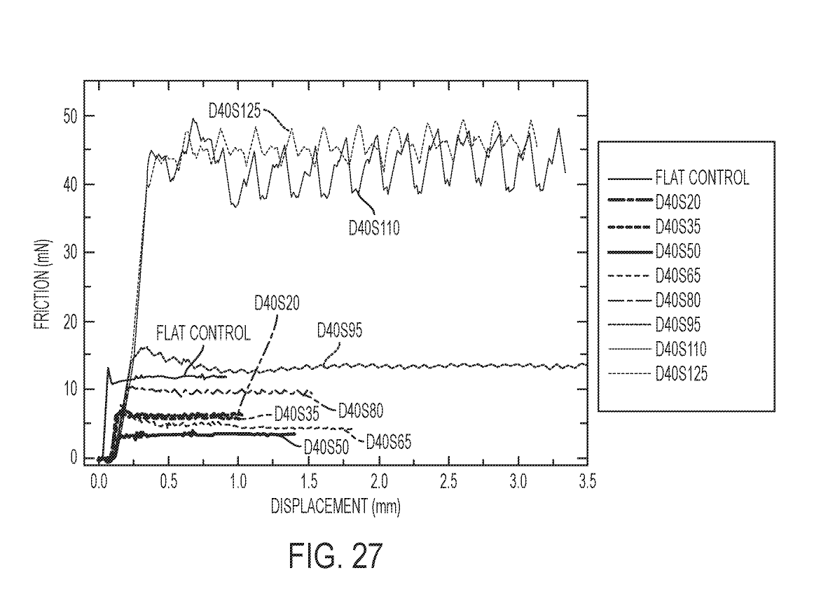

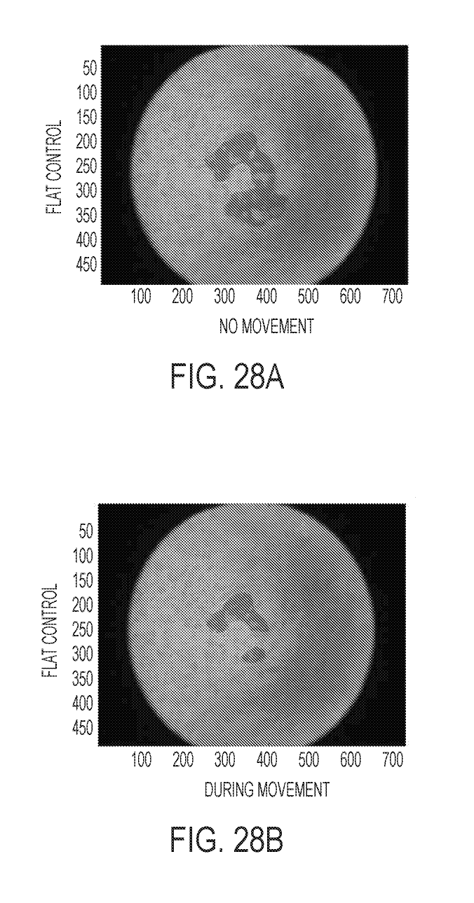

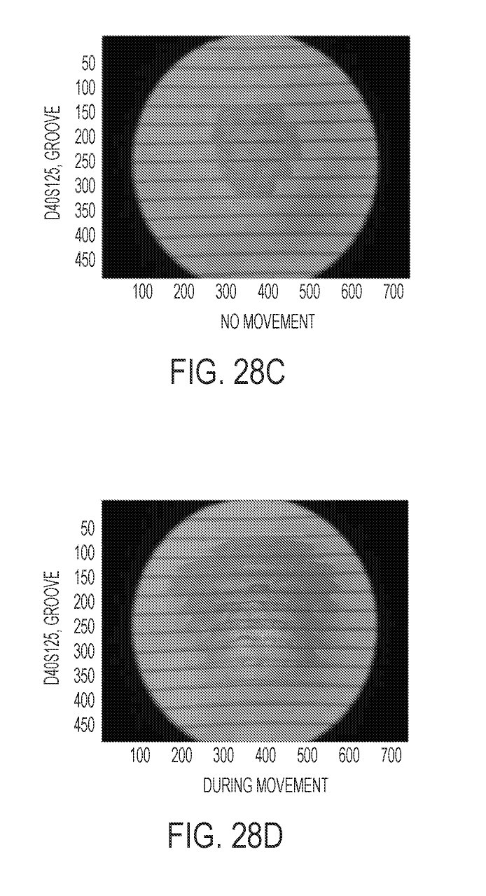

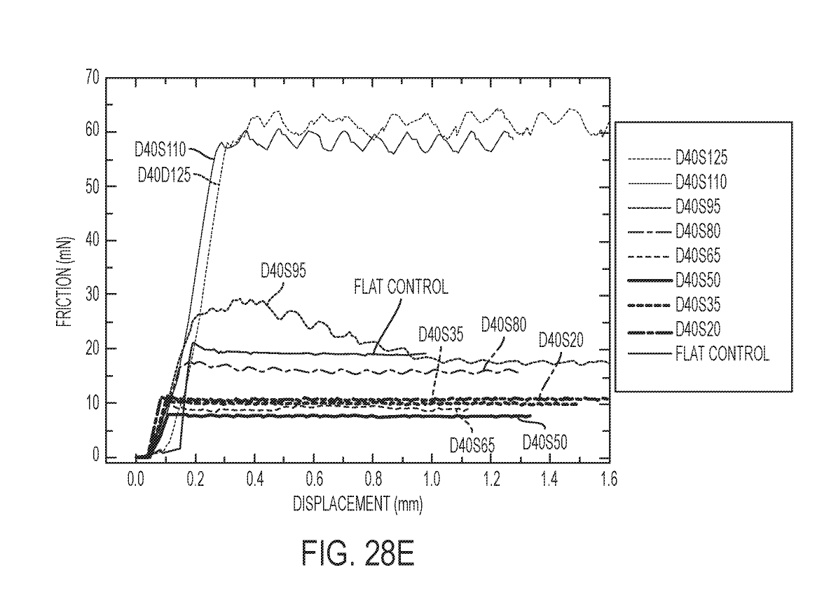

FIG. 27 shows data for film-terminated ridge array resilient members, similar to that shown in FIG. 24, having a ridge height (D) of 40 micrometers, and uniform ridge spacing (S) ranging from 20 micrometers to 125 micrometers relative to a flat control, for a load of 0.1 grams moving across the surface at a rate of 5 micrometers/second, for resilient members constructed of PDMS, having a backing layer 700 micrometers thick, and a contact film layer of about 5-10 micrometers thick, when the indenter is moved in a direction transverse to a direction of elongation of the ridges. As shown in FIG. 27, increasing the spacing between the ridges (interridge spacing) tends to reduce static friction and sliding friction relative to a flat control, as shown for the D40S20, D40S35, D40S50 resilient members. Unexpectedly, further increasing the spacing then tends to increase the static and sliding friction, as shown in relation to the D40S65 and D40S80 resilient members. Also unexpectedly, further increasing the interridge spacing increases static and sliding friction relative to the flat control, as shown with respect to the D40S95 resilient member. Further still, increasing the spacing further provides a sharp increase of approximately 3-4 times the static friction exhibited by the flat control and a sharp increase of approximately 4-5 times the sliding friction force exhibited by the flat control. Unexpectedly, interridge spacing can increase static and sliding friction, not only relative to flat control, but also relative to the resilient members having smaller spacings. This is due to the change in deformation mode resulting from the near-surface architecture that results in folding of the contact film layer and ridges, consistent with the teachings of the present invention, and as shown in FIG. 28d.

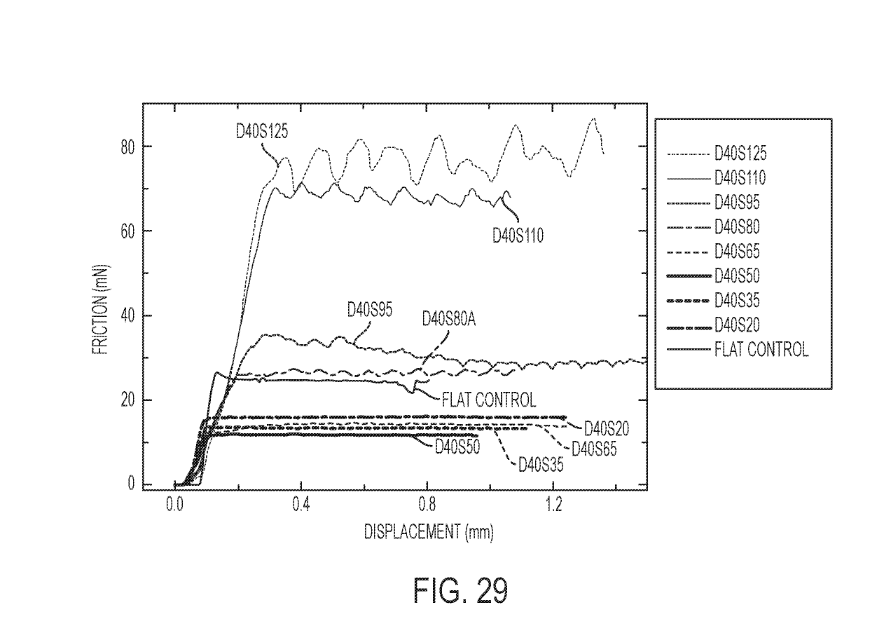

FIG. 28e shows data for film-terminated ridge array resilient members, similar to that shown in FIG. 24, having a ridge height (D) of 40 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, when the indenter is moved in a direction transverse to a direction of elongation of the ridges. However, this data reflects an increased load of 0.2 grams moving across the surface at a rate of 5 micrometers/second. FIG. 29 shows similar data, but for an increased load of 0.42 grams. Similar patterns of results are shown, in that smaller interridge spacings initially result in decreasing static and sliding friction force, but then unexpectedly yields sharply increased static and sliding friction force, not only relative to flat control, but also relative to the resilient members having smaller spacings. This is due to the change in deformation mode resulting from the near-surface architecture that results in folding of the contact film layer and/or ridges, consistent with the teachings of the present invention.

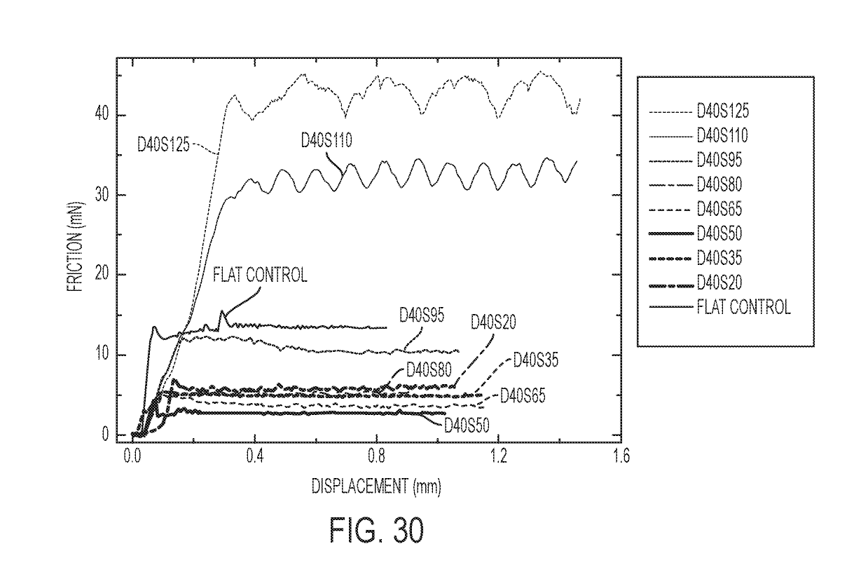

FIG. 30 shows data for film-terminated ridge array resilient members, similar to that shown in FIG. 24, having a ridge height (D) of 30 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, for a load of 0.1 grams moving in a direction transverse to a direction of elongation of the ridges at a rate of 5 micrometers/second, when the indenter is moved in a direction transverse to a direction of elongation of the ridges. A generally similar pattern of results is shown, in that smaller interridge spacings initially results in decreasing static and sliding friction force, but then unexpectedly yields sharply increased static and sliding friction force, not only relative to flat control, but also relative to the resilient members having smaller spacings. This is due to the change in deformation mode resulting from the near-surface architecture that results in folding of the contact film layer and/or ridges, consistent with the teachings of the present invention. Additionally, this Figure shows, relative to the data shown in FIG. 27, that with a shorter ridge height (D30 in FIG. 30 and D40 in FIG. 27), a wider spacing is needed to provide an increase is static and sliding friction relative to the flat sample, in that the D30S95 sample provides static and sliding friction lower than of the flat sample, and the D40S95 sample provides static and sliding friction higher than that of the flat sample. Accordingly, this graph shows that the ridge height and ridge spacing cooperate to influence static and sliding friction characteristics.

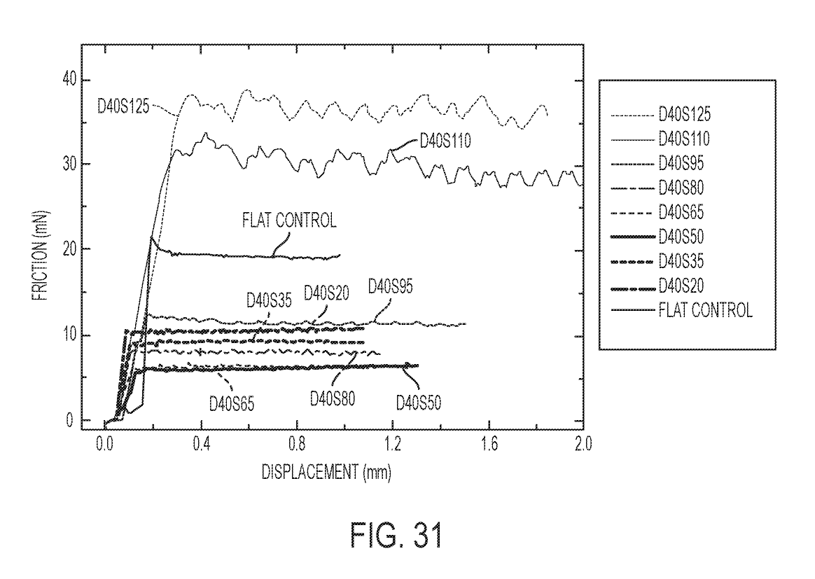

FIG. 31 shows data for film-terminated ridge array resilient members, similar to that shown in FIG. 24 having a ridge height (D) of 30 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, but for an increased load of 0.2 grams moving in a direction transverse to a direction of elongation of the ridges at a rate of 5 micrometers/second, when the indenter is moved in a direction transverse to a direction of elongation of the ridges. A generally similar pattern of results is shown, in that smaller interridge spacings initially results in decreasing static and sliding friction force, but then unexpectedly yields sharply increased static and sliding friction force, not only relative to flat control, but also relative to the smaller spacings. However, this Figure further shows that the higher normal load leads to a lesser increase in static and sliding friction, which can be observed by comparing friction force for the D30S95 samples in FIGS. 30 and 31.

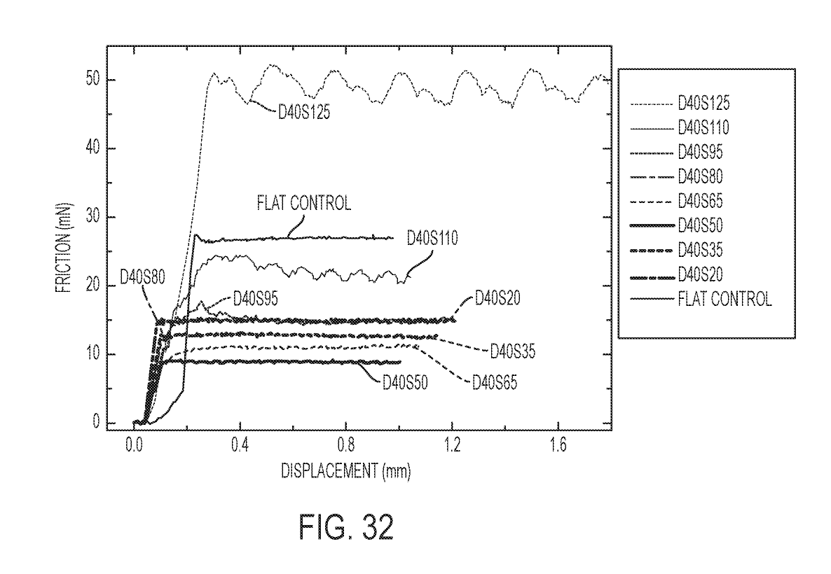

FIG. 32 shows data for film-terminated ridge array resilient members, similar to that shown in FIG. 24 having a ridge height (D) of 30 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, but for an increased load of 0.42 grams moving in a direction transverse to a direction of elongation of the ridges at a rate of 5 micrometers/second, when the indenter is moved in a direction transverse to a direction of elongation of the ridges. A generally similar pattern of results is shown, in that smaller interridge spacings initially results in decreasing static and sliding friction force, but then unexpectedly yields sharply increased static and sliding friction force, not only relative to flat control, but also relative to the smaller spacings.

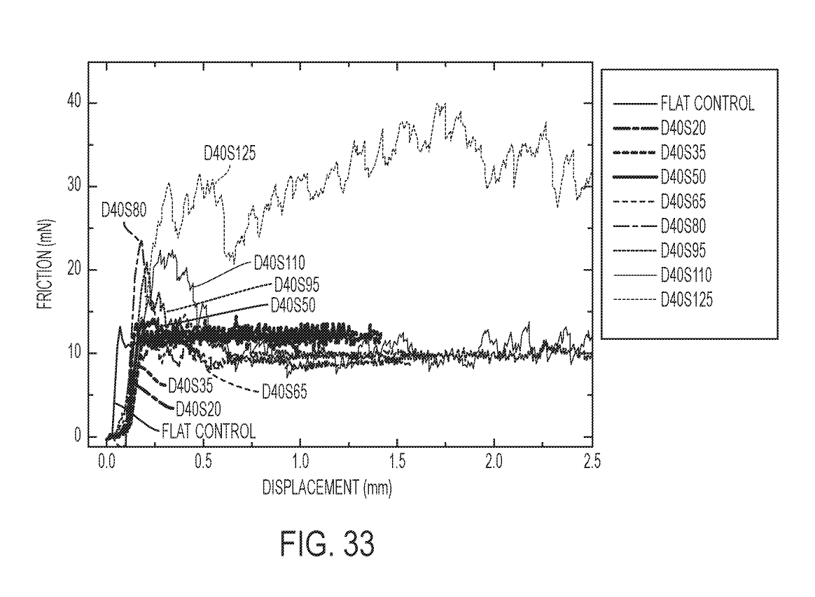

FIGS. 33-35 show data in relation to the anisotropic nature of the film-terminated ridge array resilient members, similar to that shown in FIG. 24. More specifically, these Figures show data for resilient members experiencing normal loads moving in a direction of the direction of elongation of the ridges at a rate of 5 micrometers/second, when the indenter is moved in a direction of elongation of the ridges. FIG. 33 shows data for film-terminated ridge array resilient members having a ridge height (D) of 40 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, for a load of 0.1 grams moving in a direction transverse to a direction of elongation of the ridges at a rate of 5 micrometers/second. It is shown that in this direction, slight increases in spacing initially provides very slightly increased static and sliding friction force relative to a flat sample, as shown if the D40S20, D40S35 and D40S50 samples. Further increases in the spacing then generally lead to increased static friction but lower sliding friction, as shown for the D40S65, D40S80, D40S95 and D40S110 samples. However, a further increase in the spacing then leads unexpectedly to a sharp increase in static and sliding friction relative to the flat sample, and more closely-spaced samples, as shown in relation to the D40S125 sample. However, the increase is less stable and predictable, and less extreme, than that observed with movement transverse to the direction of elongation of the ridges.

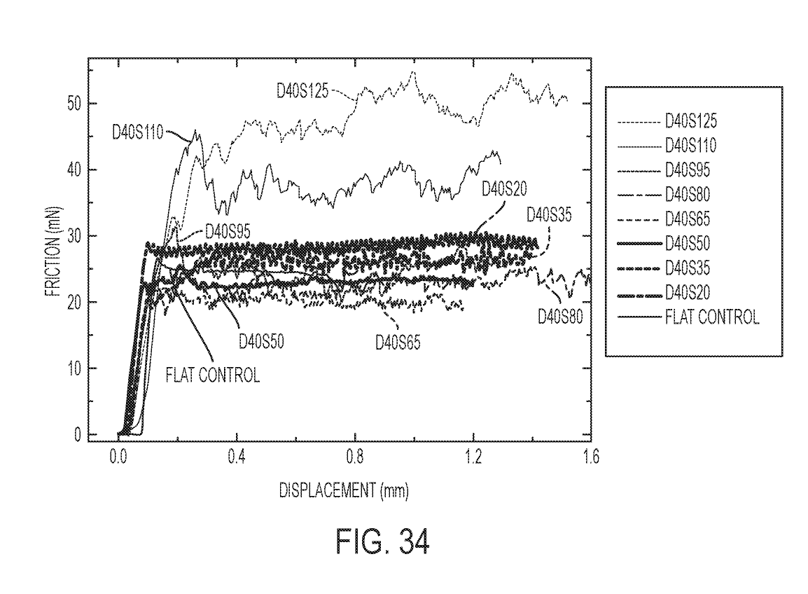

FIG. 34 shows data for film-terminated ridge array resilient members, similar to that shown in FIG. 24 having a ridge height (D) of 40 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, but for an increased load of 0.42 grams moving in a direction of elongation of the ridges at a rate of 5 micrometers/second, when the indenter is moved in a direction of elongation of the ridges. A generally similar pattern of results is shown, in that smaller interridge spacings generally initially results in decreasing static and sliding friction force, but then unexpectedly yields sharply increased static and sliding friction force, not only relative to flat control, but also relative to the smaller spacings, as shown for the D40S100 and D40S125 samples.

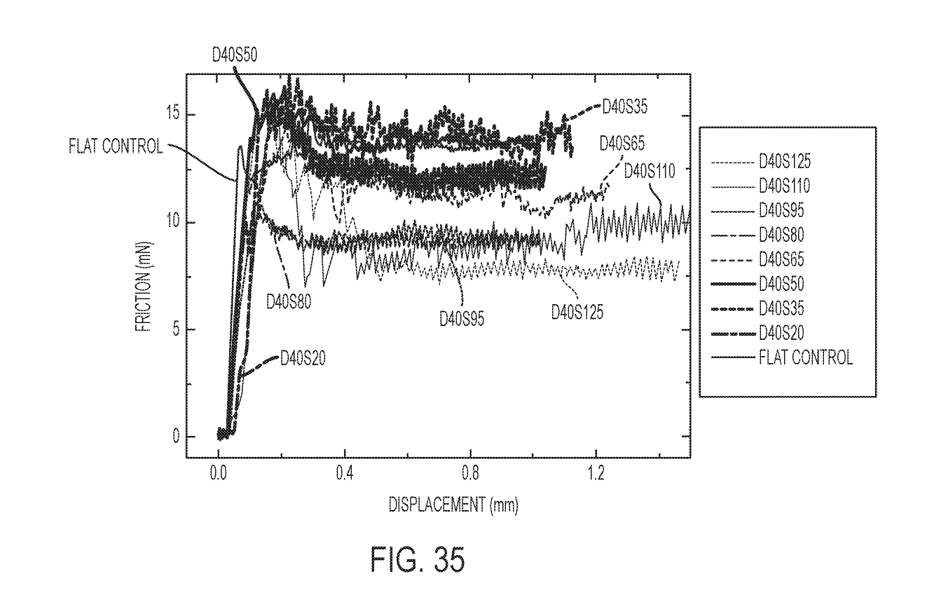

FIG. 35 shows data for film-terminated ridge array resilient members, similar to that shown in FIG. 24 having a lesser ridge height (D) of 30 micrometers, and uniform ridge spacing (S) ranging from 20 micrometers to 125 micrometers relative to a flat control, for resilient members constructed of PDMS, having a backing layer 700 micrometers thick, and a contact film layer 5-10 micrometers thick, for a load of 0.1 grams moving in a direction of elongation of the ridges at a rate of 5 micrometers/second. In this case, no sharp increase in static and sliding friction is shown. It is believed that in this case, for movement in the directly of the ridges, a ridge height of 30 micrometers, in combination with the material properties and other near-surface architecture characteristics, is insufficient to cause the resilient member to experience the fold-based mode of deformation for a load condition of 0.1 grams.

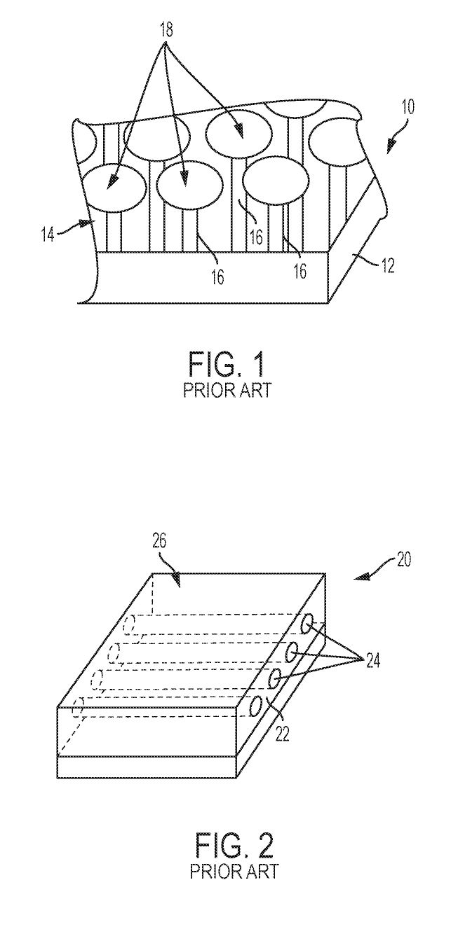

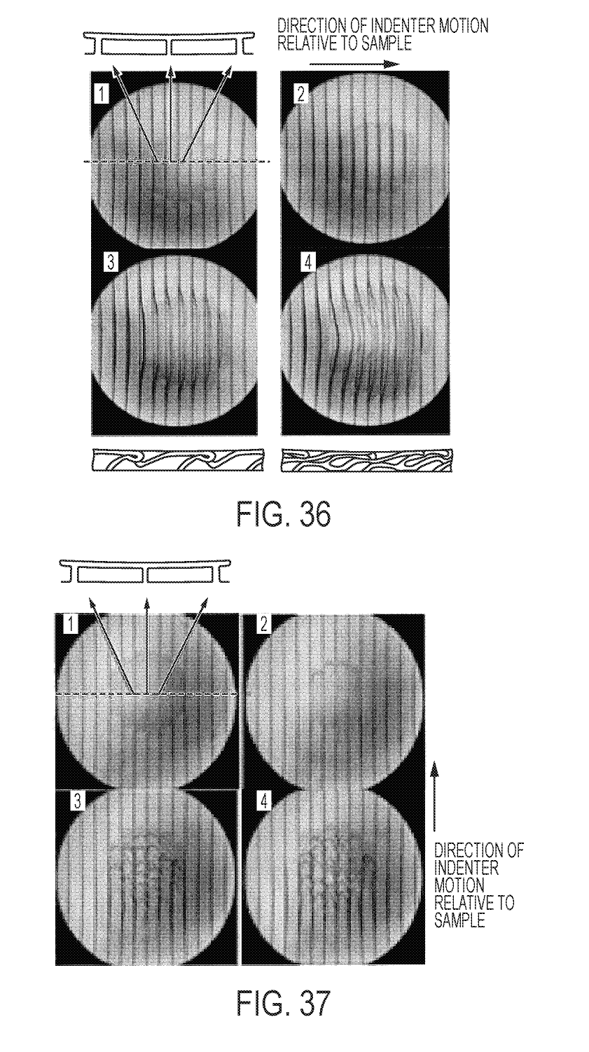

FIGS. 36-1 to 36-4 show optical micrographs showing deformation of the film-terminated ridge structure in response to movement of an indenter in a direction transverse to a direction of elongation of the ridges. Folding of the ridge/film structure consistent with the teachings of the present invention can be seen in FIG. 36-4. FIGS. 37-1 to 37-4 show optical micrographs showing deformation of the film-terminated ridge structure in response to movement of an indenter in a direction of elongation of the ridges. Buckling and/or folding of the ridge/film structure consistent with the teachings of the present invention can be seen in FIG. 37-4. Further, FIGS. 36-1-36-4 show four sequential images numbered a video of an experiment (contact region viewed through the sample) on the sample with periodic spacing of 125 micrometers. Adjacent FIGS. 36-3 and 36-4 are illustrations representing in cross-section the deformation that the structure undergoes in transition to sliding. The first event that occurs with application of shear is bending of ridges and attendant partial loss of contact between parts of the terminal film and the indenter. Samples that have relatively small periodic spacing do not go beyond this state; for them reduction of sliding friction force is therefore directly related to loss of contact due to bending of the ridges and partial detachment of the terminal film out of contact. However, when periodic spacing is sufficiently large, the subsurface structure undergoes a complex set of internal folds and deformation. This distinct change in deformation mode is characterized by deformed patterns that correlate directly with the large increase in sliding friction. It is believed that (a) the formation of multiple folds causes a large internal interfacial area that undergoes closing-opening cycles and the associated adhesion hysteresis contributes energy loss that leads to enhancement of friction, and (b) multiply-folded internal interfaces store elastic energy that is released dynamically at the trailing edge of the contact region. Because the energy is released dynamically following internal mechanical instabilities, it is lost, and this energy loss contributes to sliding friction. It is believed that there is a critical event that distinguish structures in which friction is reduced from those in which it is enhanced. More particularly, this event is understood to be the buckling of the ridge and film just as it enters the contact, which results in the formation of a fold. Further it is understood that limited folding primarily results in a mere reduction in surface contact and correspondingly, reduced friction, but that additional folding relates to strongly enhanced friction

FIGS. 37-1 to 37-4 relate to friction measurements for sliding along (in a direction of) the ridges. Sliding friction along the ridges for some samples is somewhat lower than that of the flat control. However, for samples with sufficiently large spacing, there is a significant and reproducible enhancement in sliding friction. The optical micrographs of FIGS. 37-1 to 37-4 show that during sliding the contact contains many regions of folded terminal film. Some of the folds (3 and 4) remain fixed as the sample slides under the indenter, others are created and annihilated dynamically. In cases with reduced sliding friction (1 and 2), on the other hand, the contact region during sliding is relatively smooth.

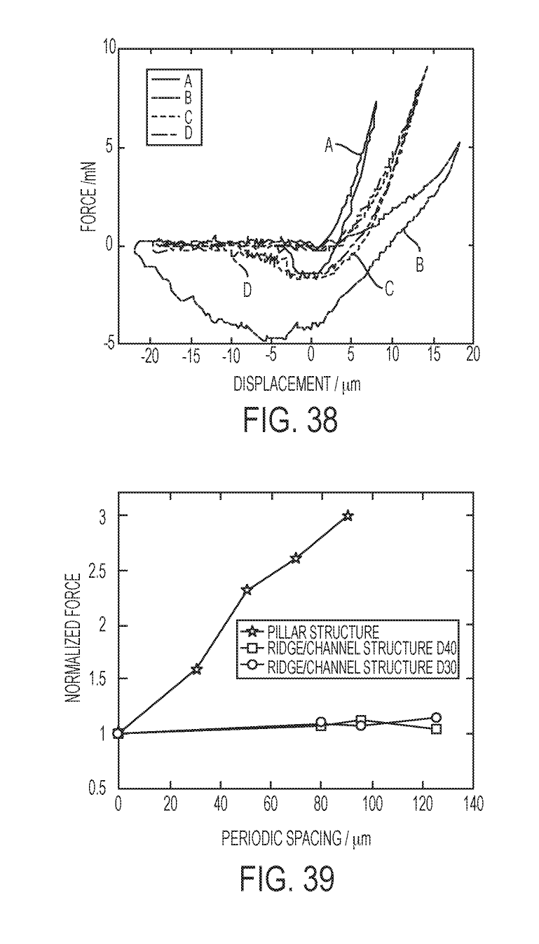

FIG. 38 provides a graph of force as a function of displacement for an adhesion test in which a smooth indenter was contacted with a structure having a flat outer/contact surface, and then withdrawn from the structure/surface in a direction normal to a plane of the flat surface, to measure adhesive force as a function of displacement into the surface of the sample. More specifically, FIG. 38 shows force-displacement traces from four different experiments, each with the same indenter but with different samples/specimens, namely, a flat unstructured control (FIG. 38, trace A), a film-terminated fibrillar/pillar specimen (fibril height of 30 microns, spacing of 90 microns) (FIG. 38, trace B), a film-terminated ridge/channel specimen (ridge height of 40 microns, spacing of 95 microns) (FIG. 38, trace C), and a film-terminated ridge/channel specimen (ridge height of 30 microns, spacing of 95 microns) (FIG. 38, trace D).

As shown in FIG. 38, a first trace A shows data from the test as conducted with a control sample, which in this exemplary test was a flat, unstructured control sample with no near surface architecture. A similar test was then conducted with an exemplary D30S90 film terminated fibrillar structure having a sharp film/fibril juncture of the type described above, and having a fibril height (D) of 30 micrometers, fibrils in a square pattern and fibril spacing (S) of 90 micrometers, but otherwise made of the same material as the control sample. Data from this test is shown in FIG. 38 as a second trace B. As will be noted from trace B, this film terminated fibrillar structure exhibited relatively high adhesion force as the indenter was withdrawn from the sample, with a peak adhesive force of almost −5 mN. Such strong adhesion force can be advantageous in certain applications, such as attachment or gripping devices, sample pick-up devices, and in transportation applications, or in essentially any application where an adhesive tape might be used.

As further shown in FIG. 38, similar tests were conducted with film terminated ridge/valley structures of the type described above. A first of those tests was conducted with a structure having a height of 40 micrometers and a spacing of 95 micrometers (trace C), and a second test was conducted with an exemplary sample having a height of 30 micrometers, and a spacing of 95 micrometers (trace D). Both samples had were constructed of the same material as the control sample. As shown by traces C and D in FIG. 38, both of these samples showed relatively low adhesion force profiles, and in particular, adhesion forces similar to those of the flat control sample shown in trace A, in that each of the three traces shows a peak adhesion force of about −1.5 mN. The film terminated ridge/valley structure thus experiences relatively low adhesion forces, but relatively high sliding friction forces, compared to a flat sample. Such characteristics can be advantageous in certain applications, such as motor vehicle tires, where low adhesion provides reduced rolling resistance but high sliding friction is useful for braking, and such as medical bandages, where resistance to sliding keeps the bandage in place but low adhesion allows its easy removal by peeling. For example, a motor vehicle tire including a film terminated ridge/valley structure consistent with the present invention, would experience low rolling resistance and associated low energy losses due to the low adhesion force profile, and high sliding resistance and enhance stopping/braking due to the high sliding friction force profile.

FIG. 39 is a chart of normalized adhesive force as a function of periodic ridge spacing in film terminated ridge structures in accordance with the present invention. In this chart, the adhesive force measured for each structured sample having near-surface architecture is normalized by dividing it by the adhesive force of the flat control sample A. This chart shows that for exemplary film-terminated ridge/valley structures having different ridge heights of 30 (D30) or 40 (D40) micrometers, the normalized force remains substantially constant and substantially equal to that of the flat unstructured control over a broad range of ridge spacings (from 0-120 micrometers). This is in contrast to the adhesive force of the film-terminated fibrillar structure, which increases significantly compared to the flat control as inter-fibrillar spacing increases.

Generally, it is noted that for a given ridge height, smaller inter-ridge spacing may be insufficient to induce the folding mode of deformation. As the inter-ridge spacing is increased, it reaches a critical value at which the film/ridge buckles and a sequence of folds forms in response to a certain load condition. For other fixed parameters, reducing film thickness generally enhances this effect by reducing bending rigidity. If the ridge height is insufficient, the film collapses onto and sticks to the substrate, and the folding mode of deformation is not obtained. Further, if the spacing between ridges is too large, the same occurs—the film collapses onto and sticks to the substrate, and the folding mode of deformation is not obtained.

Parameters of the near-surface architectures can be controlled, consistent with the present invention, by selecting a combination of parameters to either ensure folding will occur under a defined load condition, if enhanced friction force is desired, or to ensure that folding will not occur under the defined load condition, if reduced friction force is desired.

It has been observed that film terminated ridge structures having ridge spacing greater than ridge height provides structures exhibiting enhanced sliding friction characteristics relative to flat control samples. However, it is understood that there is a limit as to how wide spacing can be made before the terminal film collapses and sticks to the substrate below it, and in which the sliding friction characteristic is not enhanced, or not substantially enhanced, relative to a flat control sample.

A film-terminated ridge/valley structure exhibiting enhanced sliding friction characteristic, and avoiding film collapse, can be designed by selecting a combination of the following parameters such that the following condition is satisfied:

$$\frac{{W}_{o} {S}^{4}}{16 {GhD}^{4}} < 1$$

Wₒ is the work of adhesion of the elastomer (J/m²);

S is the ridge spacing period (distance between ridge centerlines) (m);

G is the shear modulus of the elastomer (N/m²);

his the thickness of the terminal film (m); and

D is the ridge height in meters (m).

Additionally, the parameters should be selected to cause internal folding and high sliding friction, resulting in the effect that the terminal film just entering the contact region buckles under the compressive load transmitted to it during loading. This buckling results in, or is characteristic of, the enhanced sliding friction. This can be achieved by selecting a combination of the following parameters such that the following condition is satisfied:

$$\frac{12}{{π}^{2}} \frac{τ}{{E}^{*}} {( \frac{S}{h} )}^{5 / 2} {( \frac{D}{c} )}^{3 / 2} > 2.5 ,$$

in which

τ is the average frictional stress in the contact region (N/m²);

E* is plane strain Young's modulus of elasticity of the material (N/m²);

S is the ridge spacing period (m);

h is the film thickness (m);

D is the ridge height (m); and

c is the ridge width (m).

By selecting the parameters in appropriate combinations, an increase in sliding friction of threefold or more may be obtained. By way of example, a typical value for tau is 200 kPa (200,000 N/m²) and a typical value of rubber plane strain elastic modulus is 10 MPa. If we choose h=c=10 microns and D=30 microns, this formula tells us that spacing S should exceed about 100 microns. By way of another example, for the same friction and plane strain elastic modulus, if we choose h=c=100 microns and D=300 microns, then S needs to exceed 1 mm. By way of example, motor vehicles in a range of sizes common to passenger automobiles may incorporate a film-terminated ridge/valley near surface architecture exhibiting low rolling resistance and high sliding friction by incorporating a ridge/valley structure having parameters falling in the following ranges.

For many commercial applications, typical values of these parameters are: tau is in the range of 50 kPa to 1000 kPa; E* is typically a few MPa; S is in the range 100 microns-10 mm; h in the range 10 microns-1 mm; D in the range 10 microns-1 mm.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

1. A resilient member having an anisotropic near-surface architecture, said resilient member comprising:
a unitary body constructed of an elastomeric material, said unitary body comprising:
a backing layer having a lower surface and an upper surface;
a plurality of ridge members extending from said upper surface of said backing layer, each of said plurality of ridge members being elongated along said upper surface and terminating in a distal end; and
a contact film layer joined to said distal ends of said plurality of ridge members.

2. The resilient member of claim 1, wherein adjacent ones of said plurality of ridge members are separated by an intervening valley.

3. The resilient member of claim 2, wherein each of said valleys defined between adjacent ones of said plurality of ridge members have a common rectangular cross-section.

4. The resilient member of claim 1, wherein said plurality of ridge members extend in a parallel spaced relationship.

5. The resilient member of claim 1, wherein each of said plurality of ridge members has a width that is substantially constant along its length.

6. The resilient member of claim 1, wherein said plurality of ridge members have a common width.

7. The resilient member of claim 1, wherein said plurality of ridge members have a common rectangular cross-section.

8. The resilient member of claim 1, wherein said resilient member is constructed of an elastomeric material, and wherein a flat sample of said elastomeric material exhibits a sliding friction characteristic, and wherein said resilient member has a near-surface architecture exhibiting a corresponding sliding friction characteristic that is increased by about 1.1 to about 4.0 times greater than that of the flat sample.

9. The resilient member of claim 1, wherein said resilient member is constructed of an elastomeric material, and wherein a flat sample of said elastomeric material exhibits a sliding friction characteristic, and wherein said resilient member has a near-surface architecture exhibiting a corresponding sliding friction characteristic that is attenuated by about 0.99 to about 0.2 times that of the flat sample.

10. The resilient member of claim 1, wherein said resilient member is constructed to have a material property, a ridge width, a ridge spacing, a ridge height, and a contact film thickness selected in combination to cause buckling of said contact film adjacent a leading edge of a contact zone under a predetermined load condition during sliding contact of a contact surface with the contact film.

11. A resilient member having an anisotropic near-surface architecture, said resilient member comprising:
a backing layer having a lower surface and an upper surface, said backing layer defining a thickness between said lower and upper surfaces;
a plurality of ridge members extending from said upper surface of said backing layer, each of said plurality of ridge members being elongated along said upper surface and having a width of about 2 microns to about 1000 microns, each of said plurality of ridge members extending a distance of about 2 to about 7 times the width and terminating in a distal end, adjacent ones of said plurality of ridge members being separated by a spacing of about 2 to about 15 times the width; and
a contact film layer joined to said distal ends of said plurality of ridge members, said film layer having a thickness of about 0.25 to about 5 times the width of said ridge members.

12. The resilient member of claim 11, wherein each of said plurality of ridge members has a width of about 5 microns to about 100 microns.

13. The resilient member of claim 11, wherein each said plurality of ridge members are uniformly spaced along said upper surface, the spacing between adjacent ones of said plurality of ridge members defining a respective valley.

14. The resilient member of claim 11, wherein adjacent ones of said plurality of ridge members are separated by a spacing of about 100 micros to about 130 microns.

15. The resilient member of claim 11, where each of said plurality of ridge members has a generally rectangular cross-section.

16. A resilient member having a near-surface architecture for providing enhanced friction characteristics, said resilient member comprising:
a backing layer having a lower surface and an upper surface;
an array of support members, each support member of said array extending a distance (D) from said upper surface of said backing layer and having a cross-sectional profile, adjacent ones of said array of spaced support members being separated by a spacing (S); and
a film layer joined to said distal ends of said plurality of support members, said film layer having a thickness;
wherein said backing layer, said array of support members, and said film layer are constructed of materials having respective material properties; and
wherein materials, distance, said cross-sectional profile, said spacing, and said film layer thickness are selected in combination to cause folding of at least one of said array of support members and said film layer in response to a predetermined loading condition of said resilient member.

17. The resilient member of claim 16, wherein said resilient member is constructed of an elastomeric material, and wherein a flat sample of said elastomeric material exhibits a sliding friction characteristic, and wherein said resilient member has a near-surface architecture exhibiting a corresponding sliding friction characteristic that is increased by about 1.1 to about 4.0 times greater than that of the flat sample.

18. The resilient member of claim 16, wherein said resilient member is constructed of an elastomeric material, and wherein a flat sample of said elastomeric material exhibits a sliding friction characteristic, and wherein said resilient member has a near-surface architecture exhibiting a corresponding sliding friction characteristic that is attenuated by about 0.99 to about 0.2 times that of the flat sample.

19. A resilient member having a near-surface architecture imparting enhanced static friction properties, said resilient member comprising:
a backing layer having a lower surface and an upper surface, said backing layer defining a thickness between said lower and upper surfaces;
a plurality of fibrils arranged in an array, each of said plurality of extending from said upper surface of said backing layer an terminating in a distal end; and
a contact film layer joined to said distal ends of said plurality of fibrils by a sharp juncture.

20. The resilient member of claim 19, wherein each of said sharp junctures defines a fillet that may be approximated as having a radius, the radius measuring less than about 2 micrometers.

21. The resilient member of claim 19, wherein each of said plurality of fibrils has a width, and wherein each of said sharp junctures defines a fillet that may be approximated as having a radius less than approximately 50% of the width of the fibril.

22. The resilient member of claim 19, wherein each of said plurality of fibrils has a width, and wherein each of said sharp junctures defines a fillet that may be approximated as having a radius less than approximately 20% of the width of the fibril.

23. The resilient member of claim 19, wherein said sharp junctures are formed by:
partially curing an uncured contact film layer to cause it to progress from a liquid state to a substantially solid, but not fully cured state;
placing the substantially sold, but no fully cured, contact film layer into contact with the distal ends of the plurality of fibrils; and
further curing the contact film layer to cause joining of the fibrils to the contact film layer.

24. The resilient member of claim 19, wherein said sharp junctures are formed by:
forming the resilient member as a unitary member to include said sharp junctures.

25. The resilient member of claim 19, wherein each of said plurality of fibrils has a substantially constant cross-section that does not vary adjacent a junction with the contact film layer.

26. The resilient member of claim 19, wherein said resilient member is constructed of an elastomeric material, and wherein a flat sample of said elastomeric material exhibits a sliding friction characteristic, and wherein said resilient member having a near-surface architecture exhibits a corresponding sliding friction characteristic that is increased by about 1.1 to about 2.5 times greater than that of the flat sample.

27. The resilient member of claim 19, wherein said resilient member is constructed of an elastomeric material, and wherein a flat sample of said elastomeric material exhibits a static friction characteristic, and wherein said resilient member having a near-surface architecture exhibits a corresponding static friction characteristic that is increased by about 1.1 to about 3.0 times greater than that of the flat sample.

28. The resilient member of claim 19, wherein said array comprises fibrils arranged in a square pattern.

29. The resilient member of claim 19, wherein said array comprises fibrils arranged in a hexagonal pattern.
